(19) United States
(12) Patent Application Publication
(10) Pub. No.: US 2024/0178742 A1
(43) Pub. Date: May 30, 2024

(54) POWER CONVERSION DEVICE AND METHOD FOR CONTROLLING POWER CONVERSION DEVICE

(71) Applicant: Mitsubishi Electric Corporation, Tokyo (JP)

(72) Inventor: Yoshitaka MIYAJI, Tokyo (JP)

(73) Assignee: Mitsubishi Electric Corporation, Tokyo (JP)

(21) Appl. No.: 18/281,779

(22) PCT Filed: Dec. 15, 2021
(86) PCT No.: PCT/JP2021/046198

§ 371 Date: Sep. 13, 2023

(30) Foreign Application Priority Data
Apr. 21, 2021 (WO) PCT/JP2021/016128

(51) Int. Cl. H02M 1/08; H02M 7/155

(52) U.S. Cl. CPC H02M 1/08; H02M 7/1555

(57) ABSTRACT

A power conversion device includes a semiconductor element, a temperature sensor, a sealing material sealing the semiconductor element, and a driving circuit for the semiconductor element. The temperature sensor measures the temperature of either or both of the semiconductor element and the sealing material. The driving circuit controls a voltage steepness or a voltage crest value to be applied to the semiconductor element, on the basis of temperature information measured by the temperature sensor.

### BACKGROUND ART

In electric devices for electric vehicles, an AC-DC power converter including a semiconductor device is used. In recent years, for the purpose of high efficiency and size reduction of electric devices, a power converter using a SiC device which has higher withstand voltage and can be driven at a higher frequency as compared to a conventional SI device, has been increasingly applied.

There is a power conversion device that includes a plurality of power conversion circuits, a plurality of temperature sensors, and a controller and that selects the power conversion circuit to be operated, in an order from the one in which a switching element has a lower temperature, and preferentially operates the switching element having a lower temperature, thereby warming the switching element through heat generation by itself and preventing reduction in the withstand voltage, thus enhancing efficiency (for example, Patent Document 1).

### CITATION LIST

### Patent Document

Patent Document 1: Japanese Laid-Open Patent Publication No. 2019-71730

### SUMMARY OF THE INVENTION

### Problem to be Solved by the Invention

When high-frequency driving voltage is applied to the power converter having a semiconductor element, a high electric field is generated at a termination part of the semiconductor element due to delay of formation of an electric field relaxation area, so that the withstand voltage at the interface between the semiconductor element and a sealing material is reduced. The lower the temperature is, the more remarkable the withstand voltage reduction is.

The present disclosure has been made to solve the above problem, and an object of the present disclosure is to improve the withstand voltage at the interface between a semiconductor element and a sealing material.

### Means to Solve the Problem

A power conversion device according to the present disclosure includes a semiconductor element; a temperature sensor; a sealing material sealing the semiconductor element; and a driving circuit for the semiconductor element. The temperature sensor measures temperatures of the semiconductor element and the sealing material. The driving circuit controls a voltage steepness or a voltage crest value to be applied to the semiconductor element, on the basis of temperature information measured by the temperature sensor.

A power conversion device control method according to the present disclosure is performed using a power conversion device including a semiconductor element, a temperature sensor, a sealing material sealing the semiconductor element, and a driving circuit for the semiconductor element, the method including a temperature measurement step of measuring temperatures of the semiconductor element and the sealing material by the temperature sensor; a control value selection step of selecting a voltage steepness or a voltage crest value to be applied to the semiconductor element, on the basis of temperature information measured by the temperature sensor; and a control value adjustment step of adjusting the voltage steepness or the voltage crest value to be applied to the semiconductor element, to the selected voltage steepness or voltage crest value.

### Effect of the Invention

A power conversion device and a power conversion device control method according to the present disclosure can improve the withstand voltage at the interface between a semiconductor element and a sealing material.

### BRIEF DESCRIPTION OF THE DRAWINGS

FIG. 1 is a sectional view of a power conversion device according to embodiment 1.

FIG. 2 illustrates the relationship among a voltage steepness applied to a semiconductor element of the power conversion device according to embodiment 1, withstand voltage, and a temperature.

FIG. 3 is a basic flowchart showing a control process for the semiconductor element of the power conversion device according to embodiment 1.

FIG. 4 is a flowchart showing a control process for the voltage steepness to be applied to the semiconductor element of the power conversion device according to embodiment 1.

FIG. 5 is a flowchart showing a control process for a voltage crest value to be applied to a semiconductor element of a power conversion device according to embodiment 2.

FIG. 6 is a flowchart showing a control process for a voltage steepness and a voltage crest value to be applied to a semiconductor element of a power conversion device according to embodiment 3.

FIG. 7 is a sectional view of a power conversion device according to embodiment 4.

FIG. 8 is a sectional view of a power conversion device according to embodiment 4.

FIG. 9 is a sectional view of a power conversion device according to embodiment 4.

FIG. 10 is a sectional view of a power conversion device according to embodiment 5.

FIG. 11 is a flowchart showing a control process for a voltage steepness to be applied to a semiconductor element of the power conversion device according to embodiment 5, and a heating process.

FIG. 12 is a flowchart showing a control process for a voltage crest value to be applied to a semiconductor element of a power conversion device according to embodiment 6, and a heating process.

FIG. 13 is a flowchart showing a heating process for a semiconductor element of a power conversion device according to embodiment 7.

FIG. 14 is a sectional view of a power conversion device according to embodiment 8.

FIG. 15 is a sectional view of a power conversion device according to embodiment 8.

FIG. 16 is a sectional view of a power conversion device according to embodiment 8.

FIG. 17 is a sectional view of a power conversion device according to embodiment 9.

FIG. 18 is a flowchart showing a control process for voltage steepnesses to be applied to semiconductor elements of the power conversion device according to embodiment 9.

FIG. 19 is a flowchart showing a control process for voltage crest values to be applied to semiconductor elements of a power conversion device according to embodiment 10.

FIG. 20 is a flowchart showing a control process for voltage steepnesses to be applied to semiconductor elements of a power conversion device according to embodiment 11.

FIG. 21 is a sectional view of a power conversion device according to embodiment 12.

FIG. 22 is a sectional view of a power conversion device according to embodiment 13.

FIG. 23 is a sectional view of a power conversion device according to embodiment 13.

FIG. 24 is a sectional view of a power conversion device according to embodiment 13.

FIG. 25 is a sectional view of a power conversion device according to embodiment 14.

FIG. 26 is a sectional view of a power conversion device according to embodiment 14.

FIG. 27 is a sectional view of a power conversion device according to embodiment 14.

FIG. 28 is a block diagram showing a hardware configuration example of a driving circuit of each power conversion device.

### DESCRIPTION OF EMBODIMENTS

### Embodiment 1

Embodiment 1 relates to a power conversion device including a semiconductor element, a temperature sensor, a sealing material sealing the semiconductor element, and a driving circuit for the semiconductor element, wherein the temperature sensor measures a temperature of the semiconductor element, and the driving circuit controls a voltage steepness to be applied to the semiconductor element, on the basis of temperature information measured by the temperature sensor, and withstand-voltage characteristics using the voltage steepness and the temperature of the semiconductor element as parameters, and a power conversion device control method including a required value setting step, a temperature information acquisition step, a control value selection step, a control value adjustment step, and an and determination step.

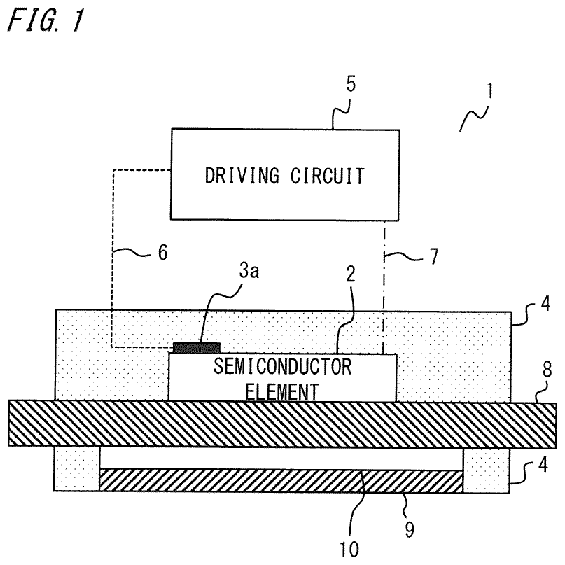

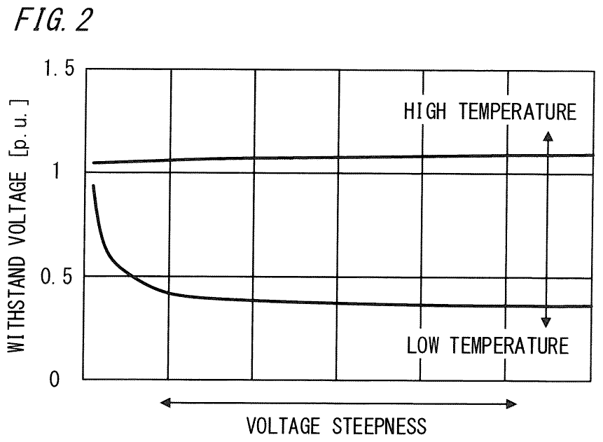

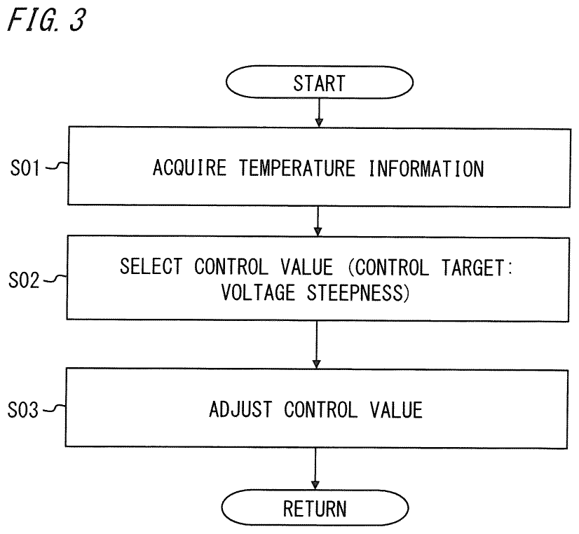

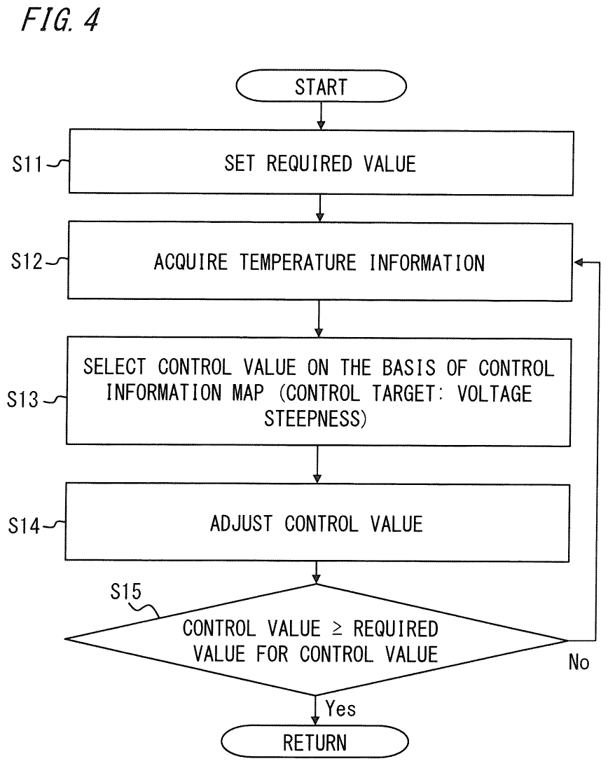

Hereinafter, the configuration and operation of the power conversion device and the power conversion device control method according to embodiment 1 will be described with reference to FIG. 1 which is a sectional view of the power conversion device, FIG. 2 which illustrates the relationship among the voltage steepness applied to the semiconductor element, the withstand voltage, and the temperature, FIG. 3 which is a basic flowchart showing a control process for the semiconductor element, and FIG. 4 which is a flowchart showing a control process for the voltage steepness to be applied to the semiconductor element.

The configuration of the power conversion device according to embodiment 1 will be described with reference to the sectional view in FIG. 1.

A power conversion device 1 includes a semiconductor element 2, a temperature sensor 3a, a sealing material 4, a driving circuit 5 for the semiconductor element 2, a temperature information transmission path 6, a control transmission path 7, a metal plate 8, a heat dissipation material 9, and a joining material 10.

The sectional view in FIG. 1 is a schematic view. For example, the metal plate 8 is a lead frame serving as connection terminals for input/output signals of the semiconductor element 2, as described later.

The semiconductor element 2 is made of Si, SiC, GaN, C, and so forth, as a main material, and is a diode, a transistor, a thyristor, a metal-oxide-semiconductor field-effect transistor (MOSFET), or an insulated-gate-bipolar-transistor (IGBT), for example. A back-side electrode of the semiconductor element 2 is joined to the metal plate 8 via a conductive joining material such as solder or a silver paste.

The temperature sensor 3a measures the temperature of either or both of the semiconductor element 2 and the sealing material 4. The temperature sensor 3a is a sensor having a temperature measurement function, such as a diode, a complementary metal oxide semiconductor (CMOS), a thermistor, or a thermocouple, for example.

The temperature sensor 3a is provided in the semiconductor element 2 or joined to the semiconductor element 2.

The sealing material 4 seals the semiconductor element 2 and the temperature sensor 3a. The sealing material 4 seals a part or the entirety of the temperature information transmission path 6 and the control transmission path 7. In addition, the sealing material 4 seals a part or the entirety of the metal plate 8, the heat dissipation material 9, and the joining material 10.

The sealing material 4 may be a sealing material not containing an additive, or a sealing material containing either or both of an organic additive and an inorganic additive. For example, the sealing material 4 may be polyphenylene sulfide resin, epoxy resin, silicone gel, or elastomer.

The driving circuit 5 is a circuit for controlling the voltage steepness, a voltage crest value, and a carrier frequency to be applied to the semiconductor element 2.

The driving circuit 5 acquires temperature information acquired by the temperature sensor 3a, via the temperature information transmission path 6. In addition, the driving circuit 5 controls the voltage steepness, the voltage crest value, and the carrier frequency to be applied to the semiconductor element 2, via the control transmission path 7. Here, the voltage steepness is a value obtained by dividing the voltage crest value at a voltage rising time or a voltage falling time by a voltage rising period or a voltage falling period.

The driving circuit 5 is provided outside the sealing material 4.

Each of the temperature information transmission path 6 and the control transmission path 7 is a harness, a wire, a metal line, or a metal plate made of metal such as copper or aluminum as a main material. Each transmission path may be formed by a combination of the above members.

The metal plate 8 is a die, a lead, a lead frame, or the like made of metal such as copper or aluminum as a main material. The metal plate 8 is joined to the heat dissipation material 9 via the joining material 10.

The lead frame serving as connection terminals for input/output signals of the semiconductor element 2 is formed of a die and a lead. A part present inside the semiconductor element 2 is called a die, and a part present outside is called a lead.

The heat dissipation material 9 is made of metal such as copper or aluminum as a main material, and dissipates heat generated inside the semiconductor element 2, to outside.

The joining material 10 may be a joining material not containing an additive, or a joining material containing either or both of an organic additive and an inorganic additive. For example, the joining material 10 may be a single-layer joining material made of epoxy resin, ceramic, or the like as a main material.

Alternatively, the joining material 10 may be a multilayer joining material obtained by combining epoxy resin, ceramic, or the like and a metal plate made of metal such as copper or aluminum as a main material, using a conductive joining material such as solder or a silver paste.

Next, with reference to FIG. 2, withstand-voltage characteristics of the semiconductor element 2 will be described using the voltage steepness and the temperature of the semiconductor element 2 as parameters.

FIG. 2 shows an example of a result of a test for evaluating the withstand voltage at the interface between the semiconductor element 2 and the sealing material 4, using the voltage steepness to be applied to the semiconductor element 2 and the temperature of either or both of the semiconductor element 2 and the sealing material 4, as parameters.

The vertical axis in FIG. 2 indicates a normalized value of the withstand voltage at the interface between the semiconductor element 2 and the sealing material 4. The horizontal axis in FIG. 2 indicates the voltage steepness applied to the semiconductor element 2. Here, a high temperature is a higher temperature than the room temperature, and a low temperature is a lower temperature than the room temperature.

In the example in FIG. 2, in a case where the temperature of the semiconductor element 2 and the sealing material 4 is the low temperature, when the voltage steepness applied to the semiconductor element 2 is reduced, the withstand voltage at the interface between the semiconductor element 2 and the sealing material 4 becomes two times or greater as compared to when the voltage steepness applied to the semiconductor element 2 is great.

In addition, in the case where the temperature of the semiconductor element 2 and the sealing material 4 is the low temperature, when the voltage steepness applied to the semiconductor element 2 is increased, the withstand voltage at the interface between the semiconductor element 2 and the sealing material 4 is reduced to ½ or smaller.

The driving circuit 5 stores a control information map continuously or discretely representing the relationship among the voltage steepness applied to the semiconductor element 2, the withstand voltage at the interface between the semiconductor element 2 and the sealing material 4, and the temperature of either or both of the semiconductor element 2 and the sealing material 4, as shown in FIG. 2.

In the following description, the withstand-voltage characteristics represented using the voltage steepness and the temperature of the semiconductor element 2 as parameters as shown in FIG. 2 are referred to as a “control information map”.

Next, control for the semiconductor element 2 executed by the driving circuit 5 on the basis of the basic flowchart in FIG. 3 will be described.

The control process in FIG. 3 includes step 1 (S01) to step 3 (S03) described below.

In a temperature information acquisition step of step 1 (S01), the driving circuit 5 acquires temperature information measured by the temperature sensor 3a.

In a control value selection step of step 2 (S02), the driving circuit 5 selects the voltage steepness to be applied to the semiconductor element 2, on the basis of the acquired temperature information.

In a control value adjustment step of step 3 (S03), the driving circuit 5 adjusts the voltage steepness to be applied to the semiconductor element 2, to the voltage steepness selected in step 2 (S02).

Next, with reference to the flowchart in FIG. 4, control for the voltage steepness of a switching signal to be applied to the semiconductor element 2, which is executed by the driving circuit 5, will be described.

FIG. 4 shows a control process which is executed by the driving circuit 5 for the semiconductor element 2 and in which the voltage steepness to be applied to the semiconductor element 2 is a control target, according to embodiment 1.

The control process in FIG. 4 is executed when the power conversion device 1 is started or when a required value for the output of the power conversion device 1 is changed by an external circuit separate from the power conversion device 1.

The control process in FIG. 4 includes step 11 (S11) to step 15 (S15) described below.

In a required value setting step of step 11 (S11), a required value for the voltage steepness to be applied to the semiconductor element 2 is set. The required value for the voltage steepness set in step 11 (S11) is determined by the external circuit separate from the power conversion device 1.

In a temperature information acquisition step of step 12 (S12), the driving circuit 5 acquires temperature information measured by the temperature sensor 3a.

In a control value selection step of step 13 (S13), the driving circuit 5 selects the voltage steepness at which the voltage crest value applied to the semiconductor element 2 becomes a maximum value or a value allowable in terms of designing, with reference to the required value for the voltage steepness set in step 11 (S11), on the basis of the acquired temperature information and the stored control information map.

In a control value adjustment step of step 14 (S14), the driving circuit 5 adjusts the voltage steepness to be applied to the semiconductor element 2, to the voltage steepness selected in step 13 (S13).

In an end determination step of step 15 (S15), the driving circuit 5 performs comparison of a magnitude relationship between the voltage steepness adjusted in step 14 (S14) and the required value for the voltage steepness set in step 11 (S11), to determine whether or not to end the sequential process.

If the voltage steepness adjusted in step 14 (S14) is smaller than the required value for the voltage steepness set in step 11 (S11), the driving circuit 5 returns to the temperature information acquisition step of step 12 (S12), to repeat the control value selection step of step 13 (S13), the control value adjustment step of step 14 (S14), and then the end determination step of step 15 (S15).

On the other hand, in the end determination step of step 15 (S15), if the voltage steepness adjusted in step 14 (S14) is equal to or greater than the required value for the voltage steepness set in step 11 (S11), the driving circuit 5 ends the process.

In the flowchart in FIG. 4, the reason for returning to the temperature information acquisition step of step 12 (S12) if the voltage steepness adjusted in step 14 (S14) is smaller than the required value for the voltage steepness set in step 11 (S11), is as follows.

It is assumed that, even if the ending condition is not satisfied with the processing in the end determination step for the first time after the process in FIG. 4 is started, the temperature of the semiconductor element 2 increases as the semiconductor element 2 operates, so that the withstand voltage property is naturally improved, that is, the withstand voltage at the interface between the semiconductor element 2 and the sealing material 4 increases. The processing performed by the driving circuit 5 in the control value selection step is assumed to be digital processing. The processing performed by the driving circuit in the control value adjustment step is assumed to be analog processing.

In embodiment 1, delay of formation of an electric field relaxation area at the termination part of the semiconductor element 2 is suppressed and the generated electric field is reduced, whereby the withstand voltage at the interface between the semiconductor element 2 and the sealing material 4 can be improved.

As described above, the power conversion device of embodiment 1 includes the semiconductor element, the temperature sensor, the sealing material sealing the semiconductor element, and the driving circuit for the semiconductor element, wherein the temperature sensor measures the temperature of the semiconductor element, and the driving circuit controls the voltage steepness to be applied to the semiconductor element, on the basis of temperature information measured by the temperature sensor, and the withstand-voltage characteristics using the voltage steepness and the temperature of the semiconductor element as parameters. In addition, the power conversion device control method includes the required value setting step, the temperature information acquisition step, the control value selection step, the control value adjustment step, and the end determination step.

Thus, the power conversion device and the power conversion device control method of embodiment 1 can improve the withstand voltage at the interface between the semiconductor element and the sealing material.

### Embodiment 2

In a power conversion device and a power conversion device control method of embodiment 2, the control target is a voltage crest value, instead of the voltage steepness which is used as the control target in embodiment 1.

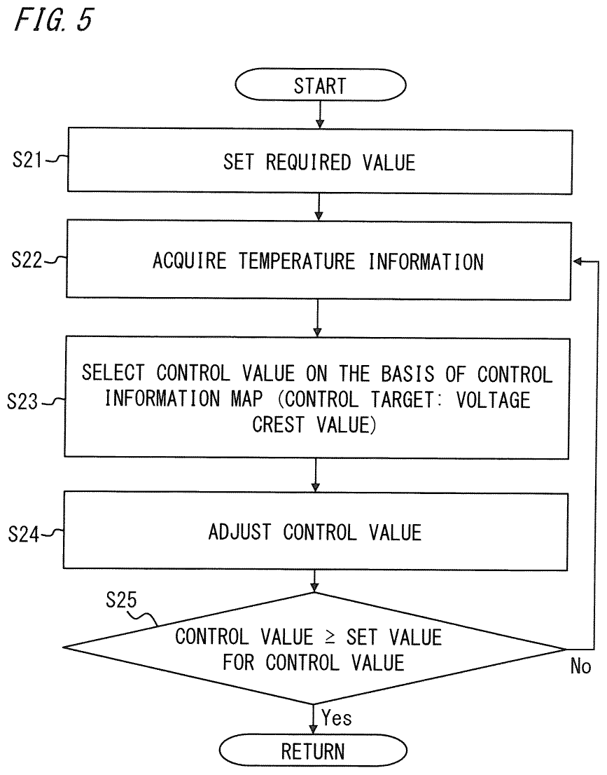

The configuration and operation of the power conversion device and the power conversion device control method according to embodiment 2 will be described with reference to FIG. 5 which is a flowchart showing a control process for the voltage crest value to be applied to the semiconductor element.

In embodiment 2, the configuration of the power conversion device is the same as that in FIG. 1 in embodiment 1, and the control information map (FIG. 2) used in the driving circuit 5 is also the same.

Therefore, with reference to FIG. 1 and FIG. 2 in embodiment 1, operation of the power conversion device of embodiment 2 will be described focusing on a difference from embodiment 1, using the flowchart in FIG. 5.

In embodiment 2, the driving circuit 5 controls the voltage crest value of a switching signal to be applied to the semiconductor element 2.

FIG. 5 shows the control process for the voltage crest value to be applied to the semiconductor element 2, which is executed by the driving circuit 5 for the semiconductor element 2 according to embodiment 2. The control process in FIG. 5 is executed when the power conversion device 1 is started or when a required value for the output of the power conversion device 2 is changed by the external circuit separate from the power conversion device 1.

In embodiment 2, the voltage steepness of a switching signal to be applied to the semiconductor element 2 is specified for the driving circuit 5 by the external circuit separate from the power conversion device 1 in advance.

The control process in FIG. 5 includes step 21 (S21) to step 25 (S25) described below.

In a required value setting step of step 21 (S21), a required value for the voltage crest value to be applied to the semiconductor element 2 is set. The required value for the voltage crest value set in step 21 (S21) is determined by the external circuit separate from the power conversion device 1.

In the temperature information acquisition step of step 22 (S22), the driving circuit 5 acquires temperature information measured by the temperature sensor 3a.

In the control value selection step of step 23 (S23), the driving circuit 5 selects the voltage crest value that is a maximum value or a value allowable in terms of designing, for the voltage crest value to be applied to the semiconductor element 2, with reference to the required value for the voltage crest value set in step 21 (S21), on the basis of the acquired temperature information and the stored control information map.

In a control value adjustment step of step 24 (S24), the driving circuit 5 adjusts the voltage crest value to be applied to the semiconductor element 2, to the voltage crest value selected in step 23 (S23).

In an end determination step of step 25 (S25), the driving circuit 5 performs comparison of a magnitude relationship between the voltage crest value adjusted in step 24 (S24) and the required value for the voltage crest value set in step 21 (S21), to determine whether or not to end the sequential process.

If the voltage crest value adjusted in step 24 (S24) is smaller than the required value for the voltage crest value set in step 21 (S21), the driving circuit 5 returns to the temperature information acquisition step of step 22 (S22), to repeat the control value selection step of step 23 (S23), the control value adjustment step of step 24 (S24), and then the end determination step of step 25 (S25).

On the other hand, in the end determination step of step 25 (S25), if the voltage crest value adjusted in step 24 (S24) is equal to or greater than the required value for the voltage crest value set in step 21 (S21), the driving circuit ends the process.

In embodiment 2, delay of formation of an electric field relaxation area at the termination part of the semiconductor element 2 is suppressed and the generated electric field is reduced, whereby the withstand voltage at the interface between the semiconductor element 2 and the sealing material 4 can be improved.

As described above, in the power conversion device and the power conversion device control method of embodiment 2, the control target is the voltage crest value, instead of the voltage steepness which is used as the control target in embodiment 1.

Thus, the power conversion device and the power conversion device control method of embodiment 2 can improve the withstand voltage at the interface between the semiconductor element and the sealing material.

### Embodiment 3

In a power conversion device and a power conversion device control method of embodiment 3, the voltage steepness or the voltage crest value is controlled on the basis of temperature information, without using the control information map.

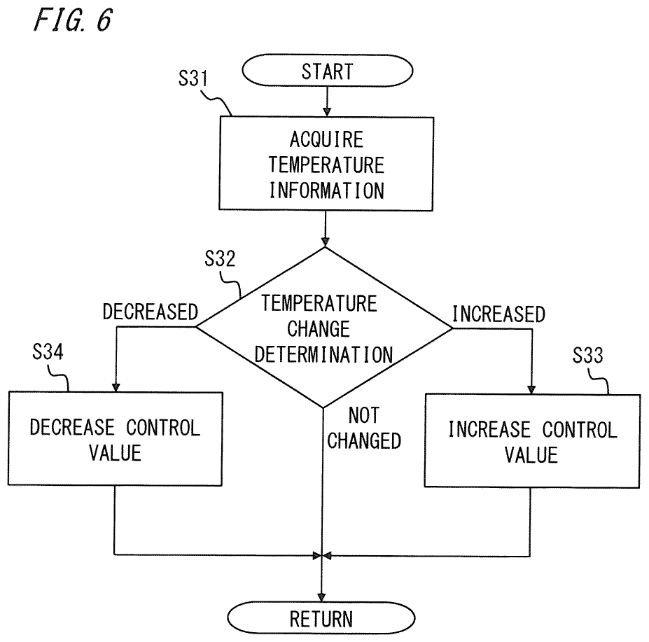

The configuration and operation of the power conversion device and the power conversion device control method according to embodiment 3 will be described with reference to FIG. 6 which is a flowchart showing a control process for the voltage steepness or the voltage crest value to be applied to the semiconductor element.

In embodiment 3, the voltage steepness or the voltage crest value is controlled using the characteristics of the control information map in FIG. 2, instead of using data of the control information map in FIG. 2.

In embodiment 3, the configuration of the power conversion device is the same as in FIG. 1 in embodiment 1. Therefore, with reference to FIG. 1 in embodiment 1, operation of the power conversion device of embodiment 3 will be described focusing on a difference from embodiment 1, using the flowchart in FIG. 6.

In embodiment 3, the driving circuit 5 controls the voltage steepness or the voltage crest value of a switching signal to be applied to the semiconductor element 2.

FIG. 6 shows the control process for the voltage steepness or the voltage crest value to be applied to the semiconductor element 2, which is executed by the driving circuit 5 for the semiconductor element 2, according to embodiment 3.

The control process in FIG. 6 is executed when the temperature of the semiconductor element 2 is changed.

The control process in FIG. 6 includes step 31 (S31) to step 34 (S34) described below.

In a temperature information acquisition step of step 31 (S31), temperature information for the semiconductor element 2 and the sealing material 4 measured by the temperature sensor 3a is acquired.

In a temperature change determination step of step 32 (S32), whether the temperature acquired in the temperature information acquisition step of step 31 (S31) has increased or decreased from the previous temperature, is determined. As a result of determination in step 32 (S32), if the temperature has increased beyond a predetermined range, the process proceeds to step 33 (S33), and if the temperature has become smaller or decreased, the process proceeds to step 34 (S34). If the temperature change is within the predetermined range, it is determined that the temperature is not changed, and the process is ended.

In a control value increase step of step 33 (S33), the voltage steepness or the voltage crest value to be applied to the semiconductor element 2 is increased from the previous value before temperature increase.

In a control value decrease step of step 34 (S34), the voltage steepness or the voltage crest value to be applied to the semiconductor element 2 is decreased from the previous value before temperature decrease.

Desirably, the change width of the voltage steepness or the voltage crest value to be applied to the semiconductor element 2 in the control value increase step and the control value decrease step is 0.2 to 0.4 p.u./° C.

In embodiment 3, the driving circuit 5 need not store the control information map shown in FIG. 2. Instead of using the control information map, the characteristics thereof is used, whereby delay of formation of an electric field relaxation area at the termination part of the semiconductor element 2 is suppressed and the generated electric field is reduced, thus achieving an effect of improving the withstand voltage at the interface between the semiconductor element 2 and the sealing material 4.

As described above, in the power conversion device and the power conversion device control method of embodiment 3, the voltage steepness or the voltage crest value is controlled on the basis of temperature information, without using the control information map.

Thus, the power conversion device and the power conversion device control method of embodiment 3 can improve the withstand voltage at the interface between the semiconductor element and the sealing material, with a simple configuration.

### Embodiment 4

Embodiment 4 shows modifications of the configuration of the power conversion device, specifically, the placement position of the temperature sensor.

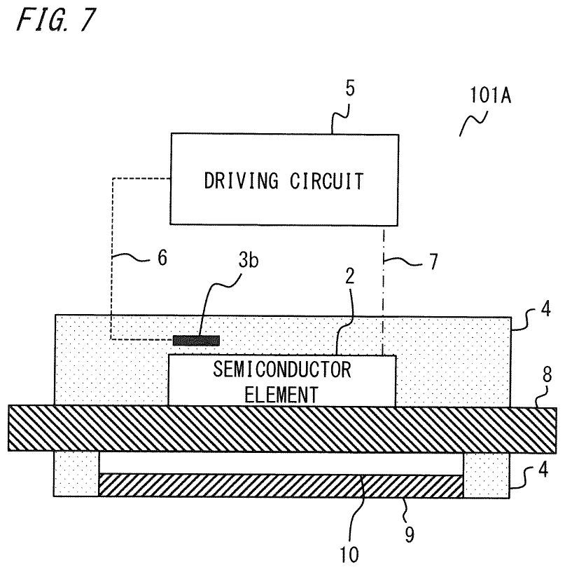

Configurations of the power conversion device according to embodiment 4 will be described with reference to FIG. 7 to FIG. 9 which are sectional views of the power conversion device.

In embodiment 4, the placement position of the temperature sensor in the power conversion device is different from that in embodiment 1. The basic configuration is the same as in FIG. 1 in embodiment 1.

In FIG. 1 in embodiment 1, the temperature sensor 3a is provided in the semiconductor element 2 or joined to the semiconductor element 2. The placement position of the temperature sensor will be described focusing on a difference from embodiment 1.

First, a case where the temperature sensor 3b is sealed in the sealing material 4 will be described with reference to FIG. 7. In FIG. 7, the power conversion device and the temperature sensor are respectively referred to as 101A and 3b, for discrimination from embodiment 1.

In FIG. 7, the temperature sensor 3b is sealed in the sealing material 4, without being joined to the semiconductor element 2. In this configuration, the temperature sensor 3b measures the temperature of the sealing material 4 or the temperature of the semiconductor element 2 via the sealing material 4.

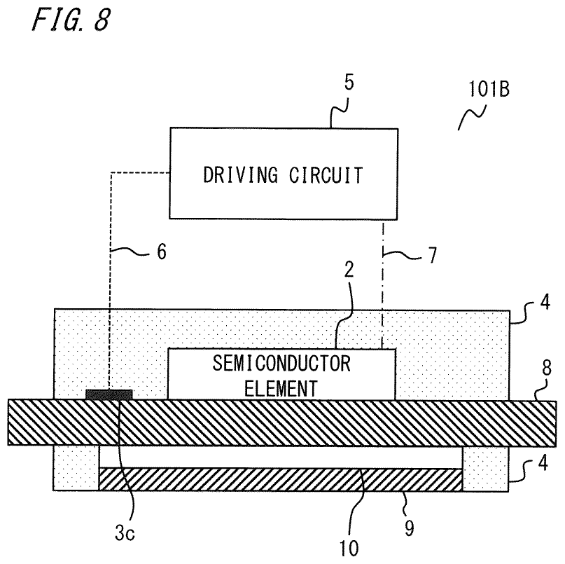

Next, a case where the temperature sensor 3c is joined to the semiconductor element 2 side of the metal plate 8 will be described with reference to FIG. 8. In FIG. 8, the power conversion device and the temperature sensor are respectively referred to as 101B and 3c, for discrimination from embodiment 1.

In FIG. 8, the temperature sensor 3c is sealed in the sealing material 4 in a state in which the temperature sensor 3c is not joined to the semiconductor element 2 and is joined to a surface of the metal plate 8 at which the semiconductor element 2 is joined. In this configuration, the temperature sensor 3c measures the temperature of the sealing material 4 or the temperature of the semiconductor element 2 via either the sealing material 4 or the metal plate 8.

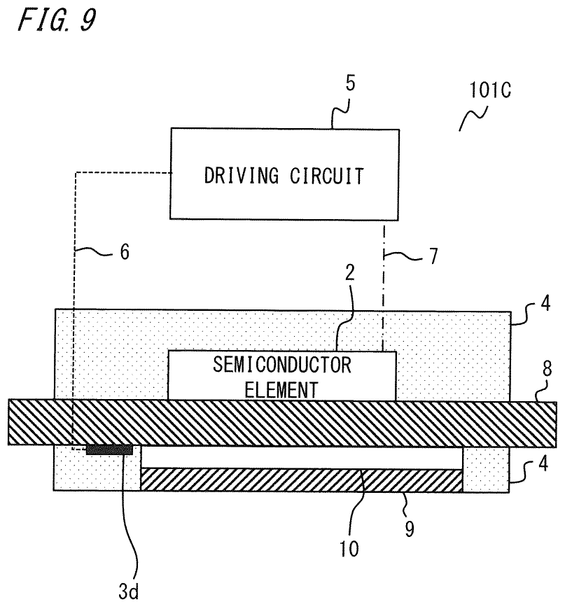

Next, a case where the temperature sensor 3d is joined to a side of the metal plate 8 opposite to the semiconductor element 2 will be described with reference to FIG. 9. In FIG. 9, the power conversion device and the temperature sensor are respectively referred to as 101C and 3d, for discrimination from embodiment 1.

In FIG. 9, the temperature sensor 3d is sealed in the sealing material 4, in a state of being joined to a surface of the metal plate 8 on a side opposite to the surface at which the semiconductor element 2 is joined. In this configuration, the temperature sensor 3d measures the temperature of the sealing material 4 or the temperature of the semiconductor element 2 via the metal plate 8.

When the modifications (FIG. 7 to FIG. 9) of the configuration of the power conversion device are collectively described, the configuration in FIG. 7 will be described as a representative.

As modifications of the placement position of the temperature sensor 3a, the cases of FIG. 7 to FIG. 9 have been described. In any of these cases, the temperature sensor 3b is sealed in the sealing material 4 or joined to the metal plate 8, instead of being provided in the semiconductor element 2 or joined to the semiconductor element 2.

Using the configurations described in FIG. 7 to FIG. 9 increases processing steps for mounting to the power conversion device 101A. However, the process for mounting the semiconductor element 2 and the temperature sensor 3b to the power conversion device 101A can be performed by separate steps, whereby the mounting process can be improved advantageously.

As described above, in the power conversion device of embodiment 4, the placement position of the temperature sensor is separated from the semiconductor element 2. Thus, the power conversion device of embodiment 4 can improve the withstand voltage at the interface between the semiconductor element and the sealing material. In addition, the mounting process for the power conversion device can be improved.

### Embodiment 5

In a power conversion device and a power conversion device control method of embodiment 5, a heat source is added to the power conversion device of embodiment 1.

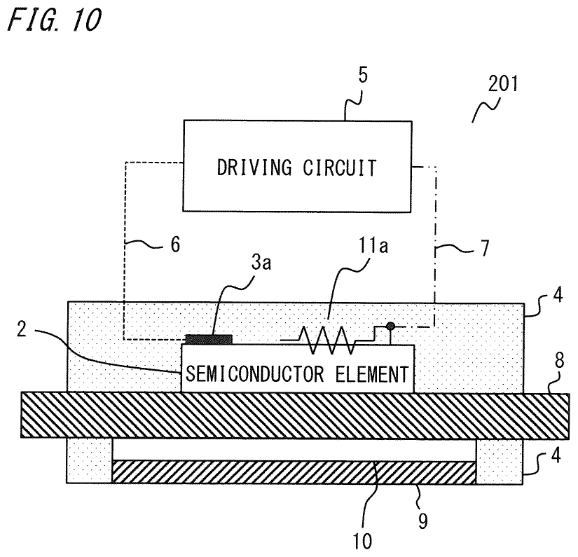

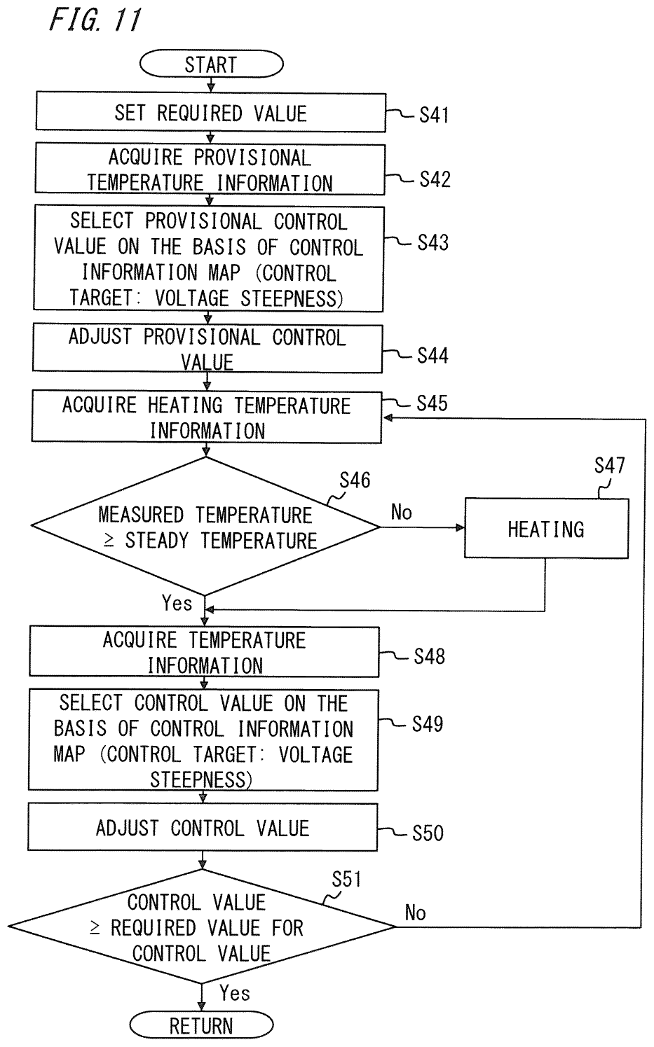

The configuration and operation of the power conversion device and the power conversion device control method according to embodiment 5 will be described with reference to FIG. 10 which is a sectional view of the power conversion device and FIG. 11 which is a flowchart showing a control process for the voltage steepness to be applied to the semiconductor element, and a heating process.

A power conversion device 201 of embodiment 5 is configured by adding a heat source 11a to the configuration in FIG. 1 in embodiment 1. The control information map (FIG. 2) used by the driving circuit 5 is the same.

Therefore, with reference to FIG. 2 in embodiment 1, the configuration and operation of the power conversion device of embodiment 5 will be described focusing on a difference from embodiment 1, using the sectional view of the power conversion device in FIG. 10 and the flowchart in FIG. 11.

In FIG. 10, the power conversion device is referred to as 201, for discrimination from embodiment 1.

First, the configuration of the power conversion device 201 will be described. The configurations other than the added heat source 11a are the same as in embodiment 1, and therefore only the hear source 11a will be described.

The heat source 11a heats the semiconductor element 2 and the sealing material 4. The heat source 11a includes, for example, a resistor, a coil, an electric heating wire, an electric heating circuit, or a heater.

The heat source 11a is provided in the semiconductor element 2 or joined to the semiconductor element 2.

The sealing material 4 seals the heat source 11a.

The driving circuit 5 controls the heat source 11a via the control transmission path 7. The control transmission path for the driving circuit 5 to control the semiconductor element 2 and the control transmission path for the driving circuit 5 to control the heat source 11a are different from each other, but are collectively represented by the control transmission path 7 without discrimination, for simplifying the drawing.

Next, control for the voltage steepness of a switching signal to be applied to the semiconductor element 2 and control for the heat source 11a, which are executed by the driving circuit 5, will be described with reference to the flowchart in FIG. 11.

FIG. 11 shows the control process for the voltage steepness to be applied to the semiconductor element 2 and the heating process of the heat source 11a, which are executed by the driving circuit 5 for the semiconductor element 2, according to embodiment 5. In the following description, when the control process and the heating process need not be discriminated from each other and are collectively mentioned, they are described as a control process, as appropriate.

The control process in FIG. 11 is executed when the power conversion device 201 is started or when a required value for the output of the power conversion device 201 is changed by the external circuit separate from the power conversion device 201.

The control process in FIG. 11 includes step 41 (S41) to step 51 (S51) described below.

In a required value setting step of step 41 (S41), a required value for the voltage steepness to be applied to the semiconductor element is set. The required value for the voltage steepness set in step 41 (S41) is determined by the external circuit separate from the power conversion device 201.

In a provisional temperature information acquisition step of step 42 (S42), the driving circuit 5 acquires temperature information measured by the temperature sensor 3a.

In a provisional control value selection step of step 43 (S43), the driving circuit 5 selects the voltage steepness at which the voltage crest value to be applied to the semiconductor element 2 becomes a maximum value or a value allowable in terms of designing, with reference to the required value for the voltage steepness set in step 41 (S41), on the basis of the acquired temperature information and the stored control information map.

In a provisional control value adjustment step of step 44 (S44), the driving circuit 5 adjusts the voltage steepness to be applied to the semiconductor element 2, to the voltage steepness selected in step 43 (S43).

In a heating temperature information acquisition step of step 45 (S45), the driving circuit 5 acquires the temperature information measured by the temperature sensor 3a.

This step is described as the heating temperature information acquisition step, for discrimination from the provisional temperature information acquisition step of step 42 (S42) and a temperature information acquisition step of step 46 (S48), though their processing contents in the driving circuit 5 are the same.

In a heating determination step of step 46 (S46), the driving circuit 5 performs comparison of a magnitude relationship between the temperature measured by the temperature sensor 3a and a steady temperature during driving of the semiconductor element 2.

As a result of the heating determination step of step 46 (S46), if the measured temperature is smaller than the steady temperature, the driving circuit 5 proceeds to step 47 (S47). If the measured temperature is equal to or greater than the steady temperature, the driving circuit 5 proceeds to step 48 (S48).

In a heating step of step 47 (S47), the driving circuit 5 drives the heat source 11a to heat the semiconductor element 2 and the sealing material 4. After the heating, the driving circuit 5 proceeds to step 48 (S48).

In the temperature information acquisition step of step 48 (S48), the driving circuit 5 acquires the temperature information measured by the temperature sensor 3a.

In a control value selection step of step 49 (S49), the driving circuit 5 selects the voltage steepness at which the voltage crest value applied to the semiconductor element 2 becomes a maximum value or a value allowable in terms of designing, with reference to the required value for the voltage steepness set in step 41 (S41), on the basis of the acquired temperature information and the stored control information map.

In a control value adjustment step of step 50 (S50), the driving circuit 5 adjusts the voltage steepness to be applied to the semiconductor element 2, to the voltage steepness selected in step 49 (S49).

In an end determination step of step 51 (S51), the driving circuit 5 performs comparison of a magnitude relationship between the voltage steepness adjusted in step 50 (S50) and the required value for the voltage steepness set in step 41 (S41), to determine whether or not to end the sequential process.

If the voltage steepness adjusted in step 50 (S50) is smaller than the required value for the voltage steepness set in step 41 (S41), the driving circuit 5 returns to the heating temperature information acquisition step of step 45 (S45).

On the other hand, in the end determination step of step 51 (S51), if the voltage steepness adjusted in step 50 (S50) is equal to or greater than the required value for the voltage steepness set in step 41 (S41), the driving circuit 5 ends the process.

The flowchart of the control process in FIG. 11 includes the provisional temperature information acquisition step of step 42 (S42), the provisional control value selection step of step 43 (S43), and the provisional control value adjustment step of step 44 (S44).

Even if the provisional temperature information acquisition step, the provisional control value selection step, and the provisional control value adjustment step are omitted, there is no problem in practice. However, by performing provisional selection and provisional adjustment for the control value before the heating temperature information acquisition step of step 45 (S45), the heating determination step of step 46 (S46), and the heating step of step 47 (S47), the ending condition can be quickly satisfied in the end determination step of step 51 (S51), to end the process.

In embodiment 5, delay of formation of an electric field relaxation area at the termination part of the semiconductor element 2 is suppressed and the generated electric field is reduced, whereby the withstand voltage at the interface between the semiconductor element 2 and the sealing material 4 can be improved.

In addition, since the semiconductor element 2, the sealing material 4, and other components are warmed, thermal stress due to local heat generation in a conduction part of the power conversion device 201 can be reduced.

As described above, in the power conversion device and the power conversion device control method of embodiment 5, the heat source is added to the power conversion device of embodiment 1.

Thus, the power conversion device and the power conversion device control method of embodiment 5 can improve the withstand voltage at the interface between the semiconductor element and the sealing material.

### Embodiment 6

In a power conversion device and a power conversion device control method of embodiment 6, the control target is the voltage crest value, instead of the voltage steepness which is used as the control target in embodiment 5.

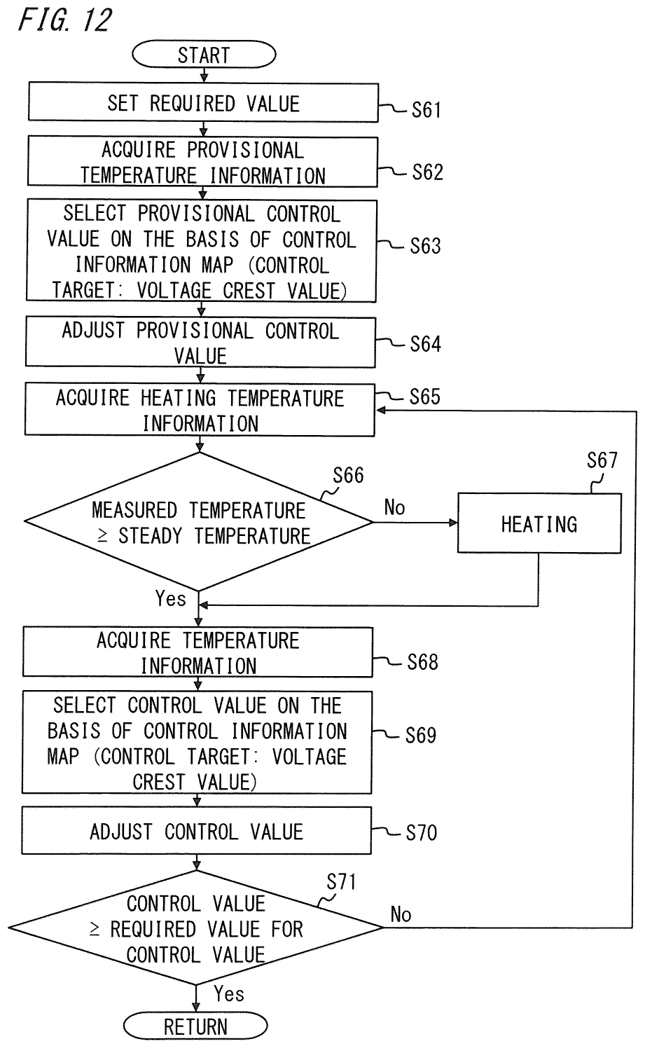

The configuration and operation of the power conversion device and the power conversion device control method according to embodiment 6 will be described with reference to FIG. 12 which is a flowchart showing a control process for the voltage crest value to be applied to the semiconductor element, an a heating process.

In embodiment 6, the configuration of the power conversion device is the same as in FIG. 10 in embodiment 5, and the control Information map (FIG. 2) used in the driving circuit 5 is also the same.

Therefore, with reference to FIG. 10 in embodiment 5 and FIG. 2 in embodiment 1, operation of the power conversion device of embodiment 6 will be described focusing on a difference from embodiment 5, using the flowchart in FIG. 12.

In embodiment 6, the driving circuit 5 performs control fox the voltage crest value of a switching signal to be applied to the semiconductor element 2 and control for the heat source 11a.

FIG. 12 shows the control process for the voltage crest value to be applied to the semiconductor element 2 and the heating process of the heat source 11a, which are executed by the driving circuit 5 for the semiconductor element 2, according to embodiment 6.

The control process in FIG. 12 is executed when the power conversion device 201 is started or when a required value for the output of the power conversion device 201 is changed by the external circuit separate from the power conversion device 201.

In embodiment 6, the voltage steepness of a switching signal to be applied to the semiconductor element 2 is specified for the driving circuit 5 by the external circuit separate from the power conversion device 201 in advance.

The control process in FIG. 12 includes step 61 (S61) to step 71 (S71) described below.

In a required value setting step of step 61 (S61), a required value for the voltage crest value to be applied to the semiconductor element 2 is set. The required value for the voltage crest value set in step 61 (S61) is determined by the external circuit separate from the power conversion device 201.

In a provisional temperature information acquisition step of step 62 (S62), the arriving circuit 5 acquires temperature information measured by the temperature sensor 3a.

In a provisional control value selection step of step 63 (S63), the driving circuit 5 selects the voltage crest value that is a maximum value or a value allowable in terms of designing, for the voltage crest value to be applied to the semiconductor element 2, with reference to the required value for the voltage crest value set in step 61 (S61), on the basis of the acquired temperature information and the stored control information map.

In a provisional control value adjustment step of step 64 (S64), the driving circuit 5 adjusts the voltage crest value to be applied to the semiconductor element 2, to the voltage crest value selected in step 63 (S63).

In a heating temperature information acquisition step of step 65 (S65), the driving circuit 5 acquires the temperature information measured by the temperature sensor 3a.

In a heating determination step of step 66 (S66), the driving circuit 5 performs comparison of a magnitude relationship between the temperature measured by the temperature sensor 3a and a steady temperature during driving of the semiconductor element 2.

As a result of the heating determination step of step 66 (S66), if the measured temperature is smaller than the steady temperature, the driving circuit 5 proceeds to step 67 (S67). If the Measured temperature is equal to or greater than the steady temperature, the driving circuit 5 proceeds to step 68 (S68).

In a heating step of step 67 (S67), the driving circuit 5 drives the heat source 11a to heat the semiconductor element 2 and the sealing material 4. After the heating, the driving circuit 5 proceeds to step 68 (S68).

In a temperature information acquisition step of step 68 (S68), the driving circuit 5 acquires the temperature information measured by the temperature sensor 3a.

In a control value selection stop of step 69 (S69), the driving circuit 5 selects the voltage crest value that is a maximum value or a value allowable in terms of designing, for the voltage crest value to be applied to the semiconductor element 2, with reference to the required value for the voltage crest value set in step 61 (S61), on the basis of the acquired temperature information and the stored control information map.

In a control value adjustment step of step 70 (S70), the driving circuit 5 adjusts the voltage crest value to be applied to the semiconductor element 2, to the voltage crest value selected in step 69 (S69).

In an end determination step of step 71 (S71), the driving circuit 5 performs comparison of a magnitude relationship between the voltage crest value adjusted in step 70 (S70) and the required value for the voltage crest value set in step 61 (S61), to determine whether or not to end the sequential process.

If the voltage crest value adjusted in step 70 (S70) is smaller than the required value for the voltage crest value set in step 61 (S61), the driving circuit 5 returns to the heating temperature information acquisition step of step 65 (S65).

On the other hand, in the end determination step of step 71 (S71), if the voltage crest value adjusted in step 70 (S70) is equal to or greater than the required value for the voltage crest value set in step 61 (S61), the driving circuit 5 ends the process.

The flowchart of the control process in FIG. 12 includes the provisional temperature information acquisition step of step 62 (S62), the provisional control value selection step of step 63 (S63), and the provisional control value adjustment step of step 64 (S64).

Even if the provisional temperature information acquisition step, the provisional control value selection step, and the provisional control value adjustment step are omitted, there is no problem in practice. However, by performing provisional selection and provisional adjustment for the control value before the heating temperature information acquisition step of step 65 (S65), the heating determination step of step 66 (S66), and the heating step of step 67 (S67), the ending condition can be quickly satisfied in the end determination step of step 71. (S71), to end the process.

In embodiment 6, delay of formation of an electric field relaxation area at the termination part of the semiconductor element 2 is suppressed and the generated electric field is reduced, whereby the withstand voltage at the interface between the semiconductor element 2 and the sealing material 4 can be improved.

In addition, since the semiconductor element 2, the sealing material 4, and other components are warmed, thermal stress due to local heat generation in a conduction part of the power conversion device 201 can be reduced.

As described above, in the power conversion device and the power conversion device control method of embodiment 6, the control target is the voltage crest value, instead of the voltage steepness which is used as the control target in embodiment 5.

Thus, the power conversion device and the power conversion device control method of embodiment 6 can improve the withstand voltage at the interface between the semiconductor element and the sealing material.

### Embodiment 7

In a power conversion device and a power conversion device control method of embodiment 7, a heat source is added to the power conversion device of embodiment 3. In embodiment 7, the voltage steepness or the voltage crest value is controlled on the basis of the temperature information, without using the control information map.

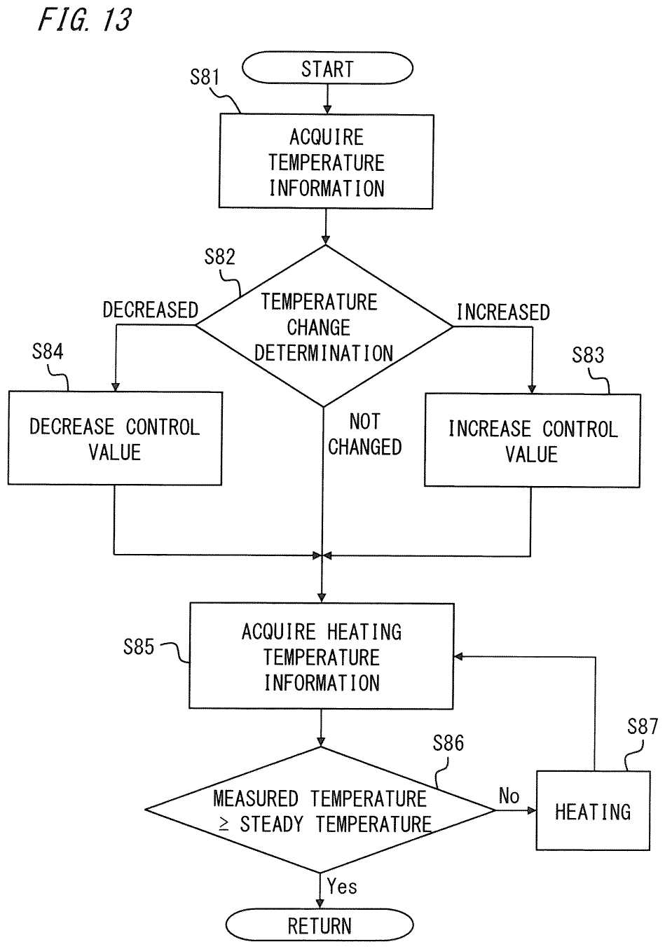

The configuration and operation of the power conversion device and the power conversion device control method according to embodiment 7 will be described with reference to FIG. 13 which is a flowchart showing a control process for the voltage steepness or the voltage crest value to be applied to the semiconductor element, and control for the heat source.

In embodiment 7, the voltage steepness or the voltage crest value is controlled using the characteristics of the control information map in FIG. 2, instead of using data of the control information map in FIG. 2.

In embodiment 7, the configuration of the power conversion device is the same as in FIG. 10 in embodiment 5.

Therefore, with reference to FIG. 10 in embodiment 5, operation of the power conversion device of embodiment 7 will be described focusing on a difference from embodiment 5, using the flowchart in FIG. 13.

In embodiment 7, the driving circuit 5 controls the voltage steepness or the voltage crest value of a switching signal to be applied to the semiconductor element 2, and performs heating control of the heat source 11a.

FIG. 13 shows the control process for the voltage steepness or the voltage crest value to be applied to the semiconductor element 2 and the heating control of the heat source 11a, which are executed by the driving circuit 5 for the semiconductor element 2, according to embodiment 7.

The control process in FIG. 13 is executed when the temperature of the semiconductor element 2 is changed.

The control process in FIG. 13 includes step 81 (S81) to step 87 (S87) described below. Step 81 (S81) to step 84 (S84) are the same as step 31 (S31) to step 34 (S34) in embodiment 3.

In a temperature information acquisition step of step 81 (S81), the temperature information for the semiconductor element 2 and the sealing material 4 measured by the temperature sensor 3a is acquired.

In a temperature change determination step of step 82 (S82), whether the temperature acquired in the temperature information acquisition step of step 81 (S81) has increased or decreased from the previous temperature, is determined.

As a result of determination in step 82 (S82), if the temperature has increased beyond a predetermined range, the process proceeds to step 83 (S83), and if the temperature has decreased, the process proceeds to step 84 (S84). If the temperature change is within the predetermined range, it is determined that the temperature is not changed, and the process proceeds to step 85 (S85).

In a control value increase step of step 83 (S83), the voltage steepness or the voltage crest value to be applied to the semiconductor element 2 is increased from the previous value before temperature increase.

In a control value decrease step of step 84 (S84), the voltage steepness or the voltage crest value to be applied to the semiconductor element 2 is decreased from the previous value before temperature decrease.

In a heating temperature information acquisition step of step 85 (S85), the driving circuit 5 acquires the temperature information measured by the temperature sensor 3a.

This step is described as the heating temperature information acquisition step, for discrimination from the temperature information acquisition step of step 81 (S81), though their processing contents in the driving circuit 5 are the same.

In a heating determination step of step 86 (S86), the driving circuit 5 performs comparison of a magnitude relationship between the temperature measured by the temperature sensor 3a and a steady temperature during driving of the semiconductor element 2.

As a result of determination in the heating determination step of step 86 (S86), if the measured temperature is smaller than the steady temperature, the driving circuit 5 proceeds to step 87 (S8?). If the measured temperature is equal to or greater than the steady temperature, the driving circuit 5 ends the process.

In a heating step of step 87 (S87), the driving circuit 5 drives the heat source 11a to heat the semiconductor element 2 and the sealing material 4. After the heating, the driving circuit 5 returns to the heating temperature information acquisition step of step 45 (S65).

In embodiment 7, the driving circuit 5 need not store the control information map shown in FIG. 2. Instead of using the control Information map, the characteristics thereof is used, whereby delay of formation of an electric field relaxation area at the termination part of the semiconductor element 2 is suppressed and the generated electric field is reduced, thus achieving an effect of improving the withstand voltage at the interface between the semiconductor element 2 and the sealing material 4.

As described above, in the power conversion device and the power conversion device control method of embodiment 7, the heat source is added to the power conversion device of embodiment 3.

Thus, the power conversion device and the power conversion device control method of embodiment 7 can improve the withstand voltage at the interface between the semiconductor element and the sealing material, with a simple configuration, without using the control information map.

### Embodiment 8

Embodiment 8 shows modifications of the configuration of the power conversion device, specifically, the placement position of the heat source.

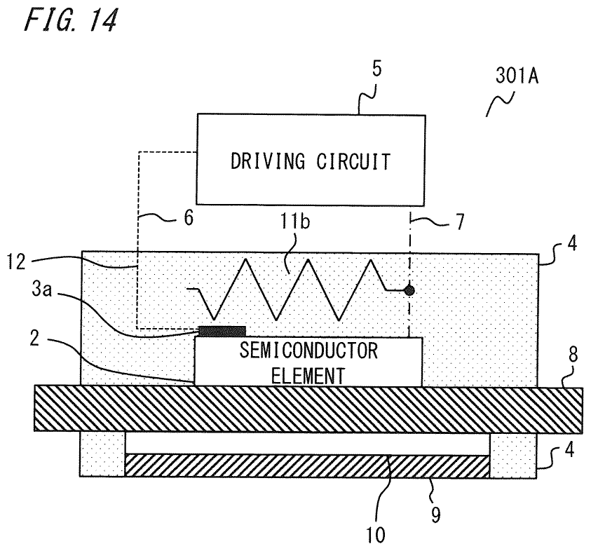

Configurations of the power conversion device according to embodiment 8 will be described with reference to FIG. 14 to FIG. 16 which are sectional views of the power conversion device.

In embodiment 8, the placement position of the heat source in the power conversion device is different from that in embodiment 5. The basic configuration is the same as in FIG. 10 in embodiment 5.

In FIG. 10 in embodiment 5, the heat source 11a is provided in the semiconductor element 2 or joined to the semiconductor element 2. The placement position of the heat source will be described focusing on a difference from embodiment 5.

First, a case where a heat source 11b is sealed in the sealing material 4 will be described with reference to FIG. 14. In FIG. 14, the power conversion device and the heat source are respectively referred to as 301A and 11b, for discrimination from embodiment 5.

In FIG. 14, the heat source 11b is sealed in the sealing material 4, without being joined to the semiconductor element 2. In this configuration, the heat source 11b heats the semiconductor element 2 via the sealing material 4.

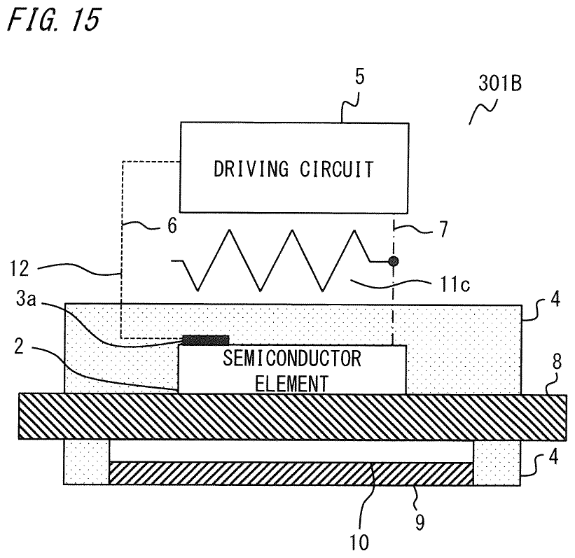

Next, a case where the heat source 11c is provided outside the sealing material 4, on the semiconductor element 2 side of the metal plate 8, will be described with reference to FIG. 15. In FIG. 15, the power conversion device and the heat source are respectively referred to as 3018 and 11c, for discrimination from embodiment 5.

In FIG. 15, a heat source 11c is provided outside the sealing material 4, on a surface side of the metal plate 8 at which the semiconductor element 2 is joined. In this configuration, the heat source 11c heats the semiconductor element 2 via the sealing material 4.

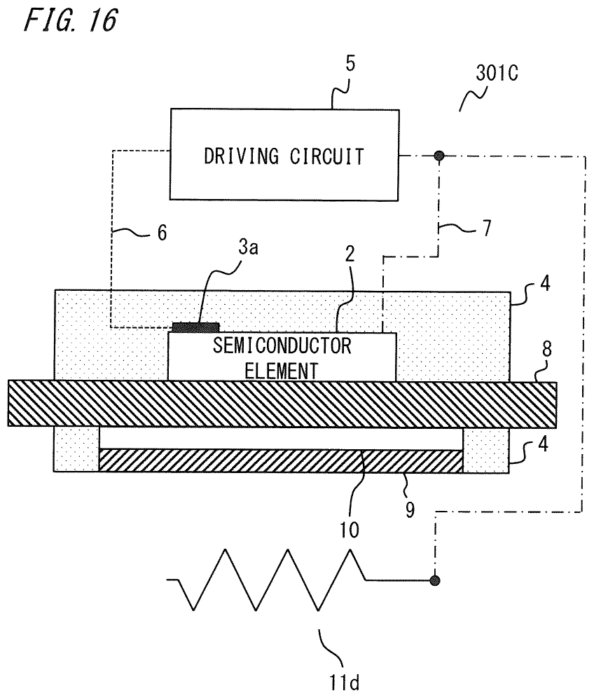

Next, a case where a heat source 11d is provided outside the heat dissipation material 9, on a side of the metal plate 8 opposite to the semiconductor element 2, will be described with reference to FIG. 16. In FIG. 16, the power conversion device and the heat source are respectively referred to as 301C and 11d, for discrimination from embodiment 5.

In FIG. 16, the heat source 11d is provided outside the heat dissipation material 9, on a side of the metal plate 8 opposite to the surface at which the semiconductor element 2 is joined. In this configuration, the heat source 11d heats the semiconductor element 2 and the sealing material 4 via the heat dissipation material 9, the joining material 10, and the metal plate 8.

When the modifications (FIG. 14 to FIG. 16) of the configuration of the power conversion device are collectively described, the configuration in FIG. 14 will be described as a representative.

As modifications of the placement position of the heat source 11a, the cases of FIG. 14 to FIG. 16 have been described. In any of these cases, the heat source 11b is sealed in the sealing material 4, provided outside the sealing material 4, or provided outside the heat dissipation material 9, instead of being provided in the semiconductor element 2 or joined to the semiconductor element 2.

Using the configurations described in FIG. 14 to FIG. 16 increases processing steps for mounting to the power conversion device 301A. However, the process for mounting the semiconductor element 2 and the heat source 11b to the power conversion device 301A can be performed by separate steps, whereby the mounting process can be improved advantageously.

As described above, in the power conversion device of embodiment 8, the placement position of the heat source is separated from the semiconductor element 2.

Thus, the power conversion device of embodiment 8 can improve the withstand voltage at the interface between the semiconductor element and the sealing material. In addition, the mounting process for the power conversion device can be improved.

### Embodiment 9

In a power conversion device and a power conversion device control method of embodiment 9, the voltage steepnesses to be applied to a plurality of semiconductor elements are controlled by one driving circuit with respect to the power conversion device of embodiment 1.

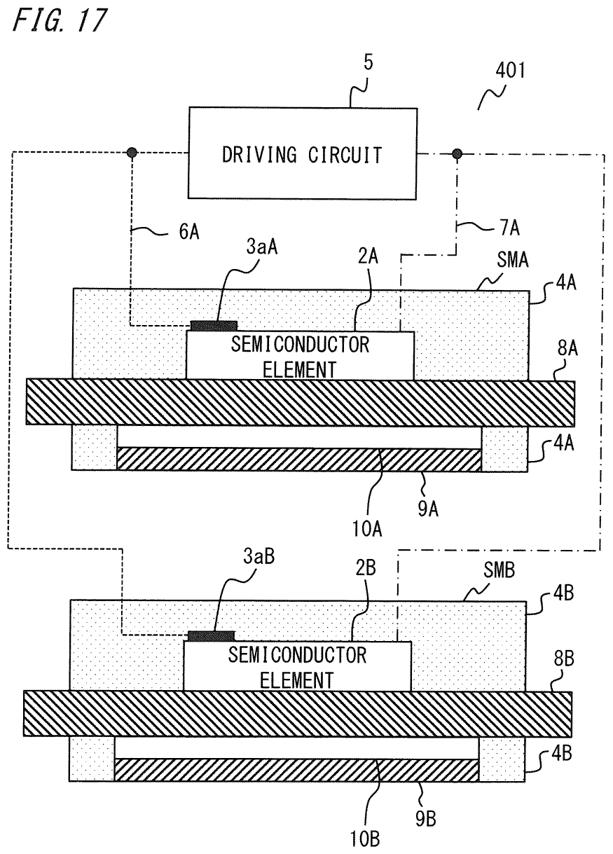

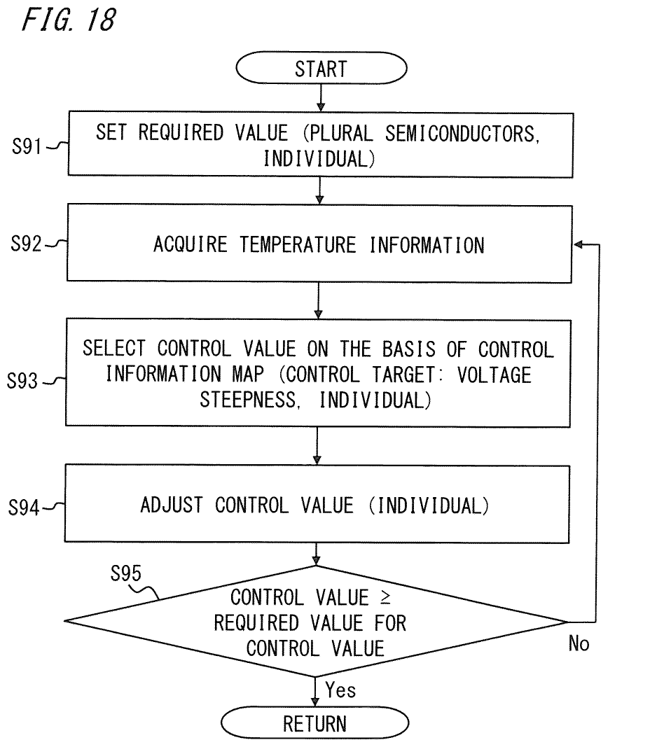

The configuration and operation of the power conversion device and the power conversion device control method according to embodiment 9 will be described with reference to FIG. 17 which is a sectional view of the power conversion device and FIG. 18 which is a flowchart showing a control process for the voltage steepnesses to be applied to the semiconductor elements.

The power conversion device is referred to as 401, for discrimination from the power conversion device of embodiment 1, and for example, semiconductor elements are referred to as 2A, 2B and temperature sensors are referred to as 3aA, 3aB.

In embodiment 9, for facilitating the understanding, a case of controlling two semiconductor elements by one driving circuit will be described, but the same applies to a case of controlling three or more semiconductor elements.

The configuration of the power conversion device 401 of embodiment 9 will be described with reference to the sectional view in FIG. 17.

The power conversion device 401 includes a semiconductor module SMA, a semiconductor module SMB, and the driving circuit 5.

The semiconductor module SMA includes the semiconductor element 2A, the temperature sensor 3aA, a sealing material 4A, a temperature information transmission path 6A, a control transmission path 7A, a metal plate 8A, a heat dissipation material 9A, and a joining material 10A.

The semiconductor module SMB includes the semiconductor element 2B, the temperature sensor 3aB, a sealing material 49, a temperature information transmission path 6B, a control transmission path 7B, a metal plate 8B, a heat dissipation material 9B, and a joining material 10B.

The driving circuit 5 controls the semiconductor element 2A of the semiconductor module SMA and the semiconductor element 2B of the semiconductor module SMB. Specifically, the driving circuit 5 controls the voltage steepnesses, the voltage crest values, and the carrier frequencies to be applied to the semiconductor element 2A and the semiconductor element 2B.

The materials and the functions of the semiconductor elements 2A, 2B, the temperature sensors 3aA, 3aB, the sealing materials 4A, 48, the temperature information transmission paths 6A, 68, the control transmission paths 7A, 7B, the metal plates 8A, 8B, the heat 21) dissipation materials 9A, 9B, and the joining materials 10A, 10B are the same as in embodiment 1, and therefore the description thereof is omitted.

The control information map FIG. 2) used for controlling the semiconductor element 2A of the semiconductor module SMA and the semiconductor element 2B of the semiconductor module SMB by the driving circuit 5 is also the same as in embodiment 1.

Next, with reference to the flowchart in FIG. 10, control for the voltage steepnesses of switching signals to be applied to the semiconductor elements 2A, 2B, which is executed by the driving circuit 5, will be described.

This control process is basically the same as that in FIG. 4 in embodiment 1, but is different in that a plurality of semiconductor elements (in embodiment 9, two semiconductor elements 2A, 2B) are controlled.

FIG. 18 shows the control process for the voltage steepnesses to be applied to the semiconductor elements 2A, 2B, which is executed by the driving circuit 5, according to embodiment 9.

The control process in FIG. 18 is executed when the power conversion device 401 is started or when a required value for the output of the power conversion device 401 is changed by the external circuit separate from the power conversion device 401.

The control process in FIG. 18 includes step 91 (S91) to step 95 (S95) described below.

In a required value setting step of step 91 (S91), individual required values for the voltage steepnesses to be applied to the semiconductor elements 2A, 2B are set. The required values for the voltage steepnesses set in step 91 (S91) are determined by the external circuit separate from the power conversion device 401.

In a temperature information acquisition step of step 92 (S92), the driving circuit 5 acquires the temperature information measured by the temperature sensors 3aA, 3aB.

In a control value selection step of step 93 (S93), the driving circuit 5 selects the respective voltage steepnesses at which the voltage crest values to be applied to the semiconductor elements 2A, 2B become maximum values or values allowable in terms of designing, with reference to the required values for the voltage steepnesses set in step 91 (S91), on the basis of the acquired temperature information and the stored control information map.

In a control value adjustment step of step 94 (S94), the driving circuit 5 adjusts the voltage steepnesses to be applied to the semiconductor elements 2A, 2B, to the voltage steepnesses selected in step 93 (S93).

In an end determination step of step 95 (S95), the driving circuit 5 performs comparison of a magnitude relationship between each voltage steepness adjusted in step 94 (S94) and the required value for each voltage steepness set in step 91 (S91), to determine whether or not to end the sequential process.

If each voltage steepness adjusted in step 94 (S94) is smaller than the required value for the voltage steepness set in step 91 (S91), the driving circuit 5 returns to the temperature information acquisition step of step 92 (S92). On the other hand, in the end determination step of step 95 (S95), if each voltage steepness adjusted in step 94 (S94) is equal to or greater than the required value for the voltage steepness set in step 91 (S91), the driving circuit 5 ends the process.

Since the driving circuit 5 controls two semiconductor elements 2A, 2B, there can be a case where the voltage steepness of the semiconductor element 2A exceeds the required value for the voltage steepness and the voltage steepness of the semiconductor element 2B does not exceed the required value for the voltage steepness, for example. In this case, the driving circuit 5 ends the process when the voltage steepnesses of both semiconductor elements 2A, 2B exceed the required values for the voltage steepnesses.

In the above description, with reference to the flowchart in FIG. 18, individual control for the voltage steepnesses of switching signals to be applied to the semiconductor elements 2A, 2B, which is executed by the driving circuit 5, has been described through the process from step 91 (S91) to step 95 (S95).

This process corresponds to a case where the flowchart in FIG. 4 in embodiment 1 is applied to a plurality of semiconductor elements and the process is performed for the voltage steepnesses to be applied to the plurality of semiconductor elements, as individual values, in the required value setting step of step 11 (S11), the control value selection step of step 13 (S13), the control value adjustment step of step 14 (S14), and the end determination step of step (S15).

In embodiment 9, delay of formation of electric field relaxation areas at the termination parts of the semiconductor elements 2A, 2B is suppressed and the generated electric fields are reduced, whereby the withstand voltage at the interface between the semiconductor element 2A and the sealing material 4A and the withstand voltage at the interface between the semiconductor element 2B and the sealing material 4B can be improved.

As described above, in the power conversion device and the power conversion device control method of embodiment 9, the voltage steepnesses to be applied to a plurality of semiconductor elements are controlled by one driving circuit.

Thus, for the plurality of semiconductor elements, the power conversion device and the power conversion device control method of embodiment 9 can improve the withstand voltages at the Interfaces between the semiconductor elements and the sealing materials.

### Embodiment 10

In a power conversion device and a power conversion device control method of embodiment 10, the control target is the voltage crest value, instead of the voltage steepness which is used as the control target in embodiment 9.

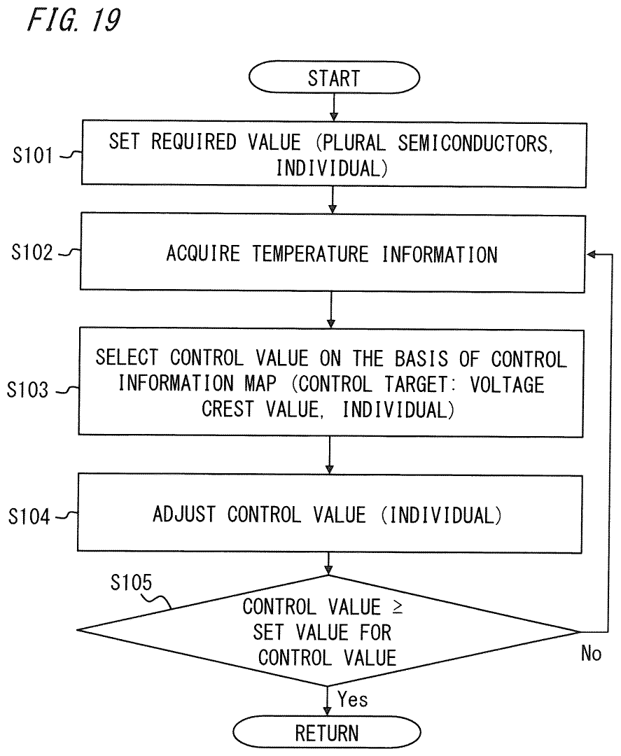

The configuration and operation of the power conversion device and the power conversion device control method according to embodiment 10 will be described with reference to FIG. 19 which is a flowchart showing the control process for the voltage crest values to be applied to two semiconductor elements.

In embodiment 10, the configuration of the power conversion device is the same as in FIG. 17 in embodiment 9, and the control information map (FIG. 2) used by the driving circuit 5 is also the same.

Therefore, with reference to FIG. 17 in embodiment 9 and FIG. 2 in embodiment 1, operation of the power conversion device of embodiment 10 will be described focusing on a difference from embodiment 9, using the flowchart in FIG. 19.

In embodiment 10, the driving circuit 5 controls the voltage crest values for switching signals to be applied to the semiconductor elements 2A, 2B.

FIG. 19 shows the control process for the voltage crest values to be applied to the semiconductor elements 2A, 2B, which is executed by the driving circuit 5, according to embodiment 10.

The control process in FIG. 19 is executed when the power conversion device 401 is started or when a required value for the output of the power conversion device 401 is changed by the external circuit separate from the power conversion, device 401.

In embodiment 10, the voltage steepnesses for switching signals to be applied to the semiconductor elements 2A, 2B are specified for the driving circuit 5 by the external circuit separate from the power conversion device 401 in advance.

The control process in FIG. 19 includes step 101 (S101) to step 105 (S105) described later.

In a required value setting step of step 101 (S101), individual required values for the voltage crest values applied to the semiconductor elements 2A, 2B are set. The required values for the voltage crest values set in step 101 (S101) are determined by the external circuit separate from the power conversion device 401.

In a temperature information acquisition step of step 102 (S102), the driving circuit 5 acquires the temperature information measured by the temperature sensors 3aA, 3aB.

In a control value selection step of step 103 (S103), the driving circuit 5 selects the voltage crest values that are maximum values or values allowable in designing, for the voltage crest values to be applied to the semiconductor elements 2A, 2b, with reference to the required values for the voltage crest values set in step 101 (S101), on the basis of the acquired temperature information and the stored control information map.

In a control value adjustment step of step 104 (S104), the driving circuit 5 adjusts the voltage crest values to be applied to the semiconductor elements 2A, 2B, to the voltage crest values selected in step 103 (S103).

In an end determination step of step 105 (S105), the driving circuit 5 performs comparison of a magnitude relationship between each voltage crest value adjusted in step 104 (S104) and the required value for each voltage crest value set in step 101 (S101), to determine whether or rot to end the sequential process.

If each voltage crest value adjusted in step 104 (S104) is smaller than the required value for the voltage crest value set in step 101 (9101), the driving circuit 5 returns to the temperature information acquisition step of step 102 (S102).

On the other hand, in the end determination step of step 105 (S105), if each voltage crest value adjusted in step 104 (S104) is equal to or greater than the required value for the voltage crest value set in step 101 (S101), the driving circuit 5 ends the process.

Since the driving circuit 5 controls two semiconductor elements 2A, 2B, there can be a case where the voltage crest value of the semiconductor element 2A exceeds the required value for the voltage crest value and the voltage crest value of the semiconductor element 2B does not exceed the required value for the voltage crest value, for example. In this case, the driving circuit 5 ends the process when the voltage crest values of both semiconductor elements 2A, 2B exceed the required values for the voltage crest values.

In the above description, with reference to the flowchart in FIG. 19, individual control for the voltage crest values of switching signals to be applied to the semiconductor elements 2A, 2B, which is executed by the driving circuit 5, has been described through the process from step 101 (S101) to step 105 (S105).

This process corresponds to a case where the flowchart in FIG. 5 in embodiment 2 is applied to a plurality of semiconductor elements and the process is performed for the voltage crest values to be applied to the plurality of semiconductor elements, as individual values, in the required value setting step of step 21 (S21), the control value selection step of step 23 (S23), the control value adjustment step of step 24 (S24), and the end determination step of step 25 (S25).

In embodiment 10, delay of formation of electric field relaxation areas at the termination parts of the semiconductor elements 2A, 2B is suppressed and the generated electric fields are reduced, whereby the withstand voltage at the interface between the semiconductor element 2A and the sealing material 4A and the withstand voltage at the interface between the semiconductor element 2B and the sealing material 4B can be improved.

As described above, in the power conversion device and the power conversion device control method of embodiment 10, the voltage crest values to be applied to a plurality of semiconductor elements are controlled by one driving circuit. Thus, for the plurality of semiconductor elements, the power conversion device and the power conversion device control method of embodiment 10 can improve the withstand voltages at the interfaces between the semiconductor elements and the sealing materials.

### Embodiment 11

In a power conversion device and a power conversion device control method of embodiment 11, a plurality of semiconductor elements are controlled using a common control value with respect to the control in embodiment 9.

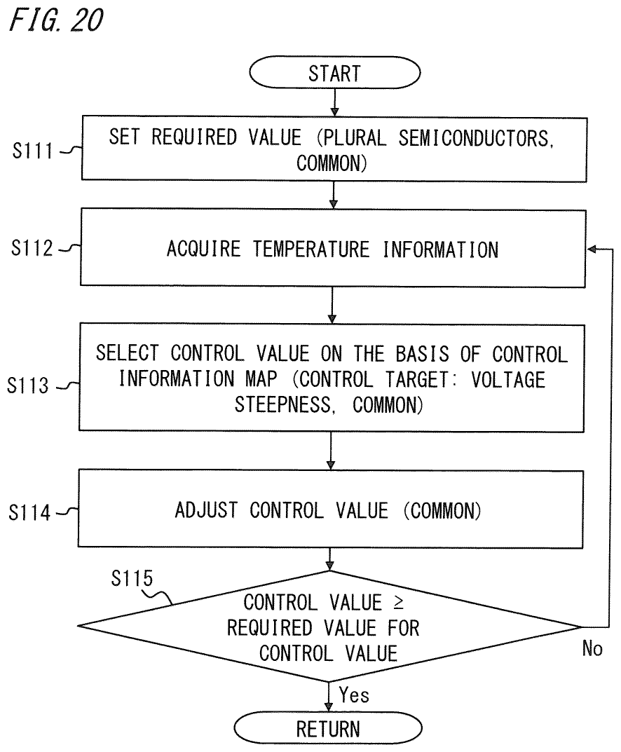

The configuration and operation of the power conversion device and the power conversion device control method according to embodiment 11 will be described with reference to FIG. 20 which is a flowchart showing a control process in which the voltage steepnesses to be applied to two semiconductor elements are controlled as a common value.

In embodiment 11, the configuration of the power conversion device is the same as in FIG. 17 in embodiment 9, and the control information map (FIG. 2) used in the driving circuit 5 is also the same.

Therefore, with reference to FIG. 17 in embodiment 9 and FIG. 2 in embodiment 1, operation of the power conversion device of embodiment 11 will be described focusing on a difference from embodiment 9, with reference to the flowchart in FIG. 20.

In embodiment 11, the driving circuit 5 controls the voltage steepnesses of switching signals to be applied to the semiconductor elements 2A, 2B, using a common value. FIG. 20 shows the control process for the voltage steepnesses to be applied to the semiconductor elements 2A, 2B, which is executed by the driving circuit 5, according to embodiment 11.

The control process in FIG. 20 is executed when the power conversion device 401 is started or when a required value for the output of the power conversion device 401 is charged by the external circuit separate from the power conversion device 401.

The control process in FIG. 20 includes step 111 (S111) to step 115 (S115) described below.

In a required value setting step of step 111 (S111), a common required value for the voltage steepnesses to be applied to the semiconductor elements 2A, 2B is set. The required value for the voltage steepnesses set in step 111 (S111) are determined by the external circuit separate from the power conversion device 401.

In a temperature information acquisition step of step 112 (S112), the driving circuit 5 acquires the temperature information measured by the temperature sensors 3aA, 3aB.

In a control value selection step of step 113 (S113), the driving circuit 5 selects a common value of the voltage steepness at which the voltage crest values to be applied to the semiconductor elements 2A, 2B become maximum values or values allowable in terms of designing, with reference to the required value for the voltage steepnesses set in step 11 (S111), on the basis of the acquired temperature information and the stored control information map.

In a control value adjustment step of step 114 (S114), the driving circuit 5 adjusts the voltage steepnesses to be applied to the semiconductor elements 2A, 2B, to the common voltage steepness selected in step 113 (S113).

In an end determination step of step 115 (S115), the driving circuit 5 performs comparison of a magnitude relationship between the voltage steepness adjusted in step 114 (S114) and the common required value for the voltage steepnesses set in step 111 (S111), to determine whether or not to end the sequential process.

If the common voltage steepness adjusted in step 114 (S114) is smaller than the common required value for the voltage steepnesses set in step 111 (S111), the driving circuit 5 returns to the temperature information acquisition step of step 112 (S112).

On the other hand, in the end determination step of step 115 (S115), if the common voltage steepness adjusted in step 114 (S114) is equal to or greater than the common required value for the voltage steepnesses set in step 111 (S111), the driving circuit 5 ends the process.

In embodiment 11, delay of formation of electric field relaxation areas at the termination parts of the semiconductor elements 2A, 2B is suppressed and the generated electric fields are reduced, whereby the withstand voltage at the interface between the semiconductor element 2A and the sealing material 4A and the withstand voltage at the interface between the semiconductor element 2B and the sealing material 4B can be improved.

In the above description, with reference to the flowchart in FIG. 20, common value control for the voltage steepnesses of switching signals to be applied to the semiconductor elements 2A, 2B, which is executed by the driving circuit 5, has been described through the process from step 111 (S111) to step 115 (S115).

This process corresponds to a case where the flowchart in FIG. 4 in embodiment 1 is applied to a plurality of semiconductor elements and the process is performed for the voltage steepnesses to be applied to the plurality of semiconductor elements, as a common value, in the required value setting step of step 11 (S11), the control value selection step of step 13 (S13), the control value adjustment step of step 14 (S14), and the end determination step of step 15 (S15).

In embodiment 11, the case of controlling the voltage steepnesses to be applied to a plurality of semiconductor elements using a common value has been described. However, it is also possible to control the voltage crest values to be applied to a plurality of semiconductor elements using a common value. In this case, the drawing and the description in embodiment 11 can be applied also to embodiment 10 in the same manner and therefore the description thereof is omitted.

As described above, in the power conversion device and the power conversion device control method of embodiment 11, the voltage steepnesses to be applied to a plurality of semiconductor elements are controlled using a common value by one driving circuit.

Thus, for the plurality of semiconductor elements, the power conversion device and the power conversion device control method of embodiment 11 can improve the withstand voltages at the interfaces between the semiconductor elements and the sealing materials.

### Embodiment 12

In a power conversion device and a power conversion device control method of embodiment 12, the voltage steepnesses or the voltage crest values to be applied to a plurality of semiconductor elements are controlled by one driving circuit with respect to the power conversion device of embodiment 1.

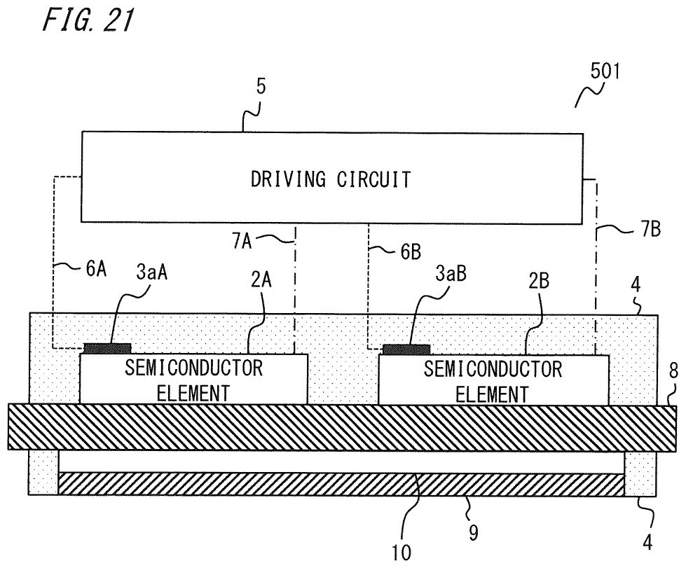

The power conversion device according to embodiment 12 will be described with reference to FIG. 21 which is a sectional view of the power conversion device.

The power conversion device is referred to as 501, for discrimination from the power conversion device of embodiment 1, and for example, semiconductor elements are referred to as 2A, 2B and temperature sensors are referred to as 3aA, 3aB.

In embodiment 12, for facilitating the understanding, a case of controlling two semiconductor elements by one driving circuit will be described, but the same applies to a case of controlling three or more semiconductor elements.

The configuration of the power conversion device 501 of embodiment 12 will be described with reference to the sectional view in FIG. 21.

The power conversion device 501 includes the semiconductor elements 2A, 2B, the temperature sensors 3aA, 3aB, the sealing material 4, the driving circuit 5, the temperature information transmission paths 6A, 6B, the control transmission paths 7A, 7B, the metal plate 8, the heat dissipation material 9, and the joining material 10.

The driving circuit 5 controls the semiconductor element 2A and the semiconductor element 2B. Specifically, the driving circuit 5 controls the voltage steepnesses, the voltage crest values, and the carrier frequencies to be applied to the semiconductor element 2A and the semiconductor element 2B.

The materials and the functions of the semiconductor elements 2A, 2B, the temperature sensors 3aA, 3aB, the sealing material 4, the temperature information transmission paths 6A, 6B, the control transmission paths 7A, 7E, the metal plate 9, the heat dissipation material 9, and the joining material 10, are the same as in embodiment 1, and therefore the description thereof is omitted.

The control information map (FIG. 2) used for controlling the semiconductor elements 2A, 2B by the driving circuit 5 is also the same as in embodiment 1.

The control methods for the voltage steepnesses, the voltage crest values, and the carrier frequencies of switching signals to be applied to the semiconductor elements 2A, 2B, which are executed by the driving circuit 5, are the same as in embodiment 9, 10, or 11.

In embodiment 12, delay of formation of electric field relaxation areas at the termination parts of the semiconductor elements 2A, 2B is suppressed and the generated electric fields are reduced, whereby the withstand voltages at the interfaces between the semiconductor elements 2A, 2B and the sealing material 4 can be improved.

As described above, in the power conversion device and the power conversion device control method of embodiment 12, the voltage steepnesses or the voltage crest values to be applied to a plurality of semiconductor elements are controlled by one driving circuit.

Thus, for the plurality of semiconductor elements, the power conversion device and the power conversion device control method of embodiment 12 can improve the withstand voltages at the interfaces between the semiconductor elements and the sealing material.

### Embodiment 13

Embodiment 13 shows modifications of the configuration of the power conversion device, specifically, the placement positions and the number of the temperature sensors.

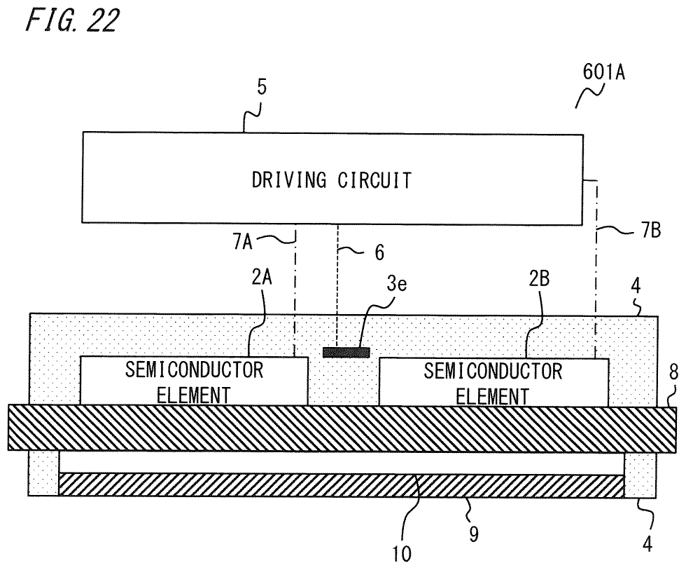

Configurations of the power conversion device according to embodiment 13 will be described with reference to FIG. 22 to FIG. 24 which are sectional views of the power conversion device.

In embodiment 13, the placement positions and the number of the temperature sensors in the power conversion device are different from those in embodiment 12. The basic configuration is the same as in FIG. 21 in embodiment 12.

In FIG. 21 in embodiment 12, the number of the temperature sensors 3aA, 3aB is the same as the number of the semiconductor elements 2A, 2B, and the temperature sensors 3aA, 3aB are provided in the semiconductor elements 2A, 2B or joined to the semiconductor elements 2A, 2B. The placement positions and the number of the temperature sensors will be described focusing on a difference from embodiment 12.

First, a case where a temperature sensor 3e is sealed in the sealing material 4 will be described with reference to FIG. 22. In FIG. 22, the power conversion device and the temperature sensor are respectively referred to as 601A and 3e, for discrimination from embodiment 12.

In embodiment 13, for facilitating the understanding, a case of measuring the temperatures of two semiconductor elements by one temperature sensor will be described, but the same applies to a case of measuring the temperatures of three or more semiconductor elements.

In FIG. 22, one temperature sensor 3e is provided and is sealed in the sealing material 4, without being joined to the semiconductor elements 2A, 2B. In this configuration, the temperature sensor 3e measures the temperature of the sealing material 4 or the temperatures of the semiconductor elements 2A, 23 via the sealing material 4.

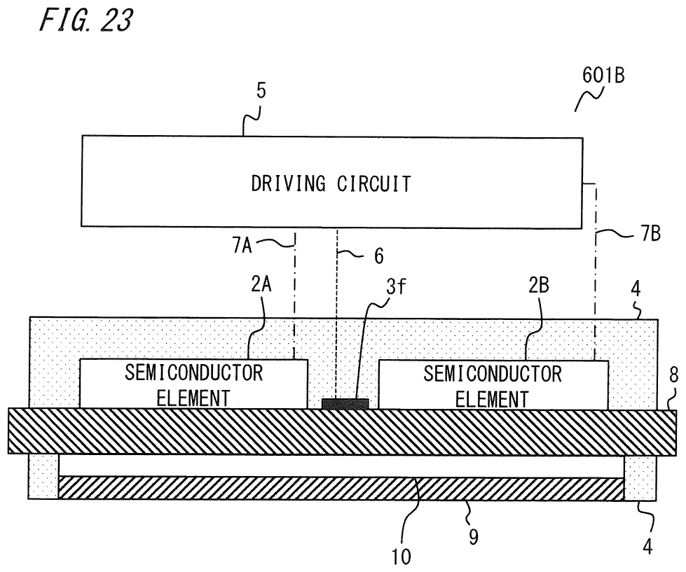

Next, a case where a temperature sensor 3f is joined to the semiconductor element 2A, 2B side of the metal plate 8 will be described with reference to FIG. 23. In FIG. 23, the power conversion device and the temperature sensor are respectively referred to as 601B and 3f, for discrimination from embodiment 12.

In FIG. 23, the temperature sensor 3f is sealed in the sealing material 4 in a state in which the temperature sensor 3f is not joined to the semiconductor elements 2A, 2B and is joined to a surface of the metal plate 8 at which the semiconductor elements 2A, 2B are joined. In this configuration, the temperature sensor 3f measures the temperature of the sealing material 4 or the temperatures of the semiconductor elements 2A, 2B via either the sealing material 4 and the metal plate 8.

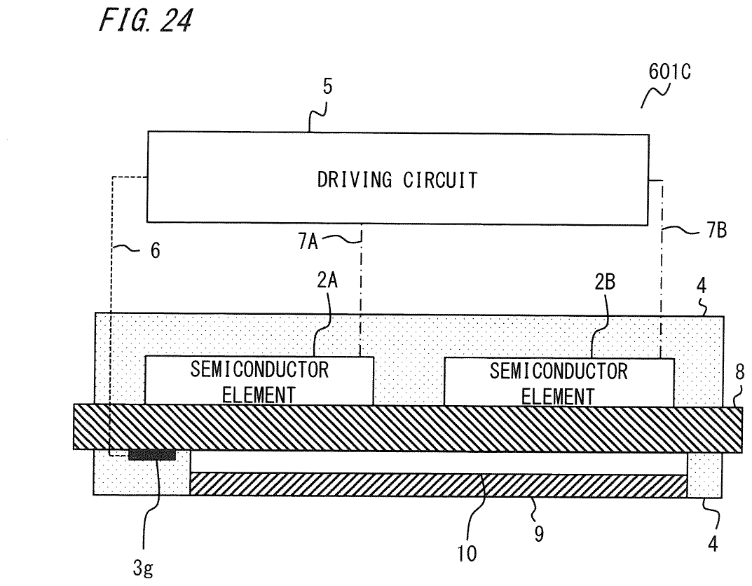

Next, a case where a temperature sensor 3g is joined to a side of the metal plate 8 opposite to the semiconductor elements 2 will be described with reference to FIG. 24. In FIG. 24, the power conversion device and the temperature sensor are respectively referred to ds 601C and 39, for discrimination from embodiment 1.

In FIG. 24, the temperature sensor 3g is sealed in the sealing material 4, in a state of being joined to a surface of the metal plate 8 on a side opposite to the surface at which the semiconductor elements 2A, 2B are joined. In this configuration, the temperature sensor 3g measures the temperature of the sealing material 4 or the temperature of the semiconductor elements 2A, 2B via the metal plate 8.

When the modifications (FIG. 22 to FIG. 24) of the configuration of the power conversion device are collectively described, the configuration in FIG. 22 will be described as a representative.

As modifications of the placement position of the temperature sensor 3e, the cases of FIG. 22 to FIG. 24 have been described. In any of these cases, the temperature sensor 3e is sealed in the sealing material 4 or joined to the metal plate 8, instead of being provided in the semiconductor elements 2A, 2B or joined to the semiconductor elements 2A, 2B.

Using the configurations described in FIG. 22 to FIG. 24 increases processing steps for mounting to the power conversion device 601A. However, the process for mounting the semiconductor elements 2A, 2B and the temperature sensor 3e to the power conversion device 601A can be performed by separate steps, whereby the mounting process can be improved advantageously.

As described above, in the power conversion device of embodiment 13, the placement position of the temperature sensor is separated from the semiconductor elements 2A, 2B.

Thus, the power conversion device of embodiment 13 can improve the withstand voltages at the interfaces between the semiconductor elements and the sealing material. In addition, the mounting process for the power conversion device can be improved.

### Embodiment 14

Embodiment 14 shows modifications of the configuration of the power conversion device, that is, the placement positions and the number of the heat sources.

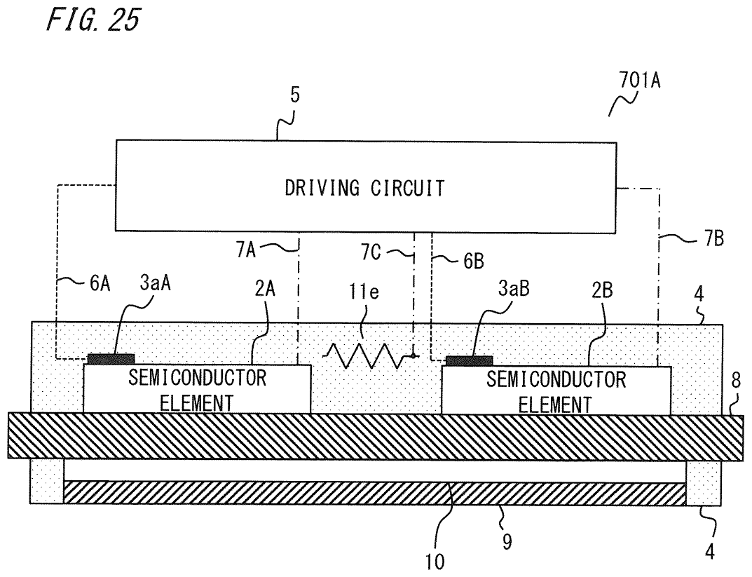

Configurations of the power conversion device according to embodiment 14 will be described with reference to FIG. 25 to FIG. 27 which are sectional views of the power conversion device.

In embodiment 14, the placement positions and the number of the heat sources in the power conversion device are different from those in simple combination of embodiments 5 and 12. The basic configuration is the same as in FIG. 10 in embodiment 5 and FIG. 21 in embodiment 12. That is, the temperature sensors 3aA, 3aB are provided in the semiconductor elements 2A, 2B or joined to the semiconductor elements 2A, 2B.

FIG. 10 in embodiment 5, the heat source 11a is provided in the semiconductor element 2 or joined to the semiconductor element 2. The placement positions and the number of the heat sources will be described focusing on a difference from those in simple combination of embodiments 5 and 12. The driving circuit 5 controls a heat source 11e via a control transmission path 7C.

First, a case where the heat source 11e is sealed in the sealing material 4 will be described with reference to FIG. 25. In FIG. 25, the power conversion device and the heat source are respectively referred to as 703A and Ile, for discrimination from embodiments 5 and 12.

In embodiment 14, for facilitating the understanding, a case of heating two semiconductor elements by one heat source will be described, but the same applies to a case of heating three or more semiconductor elements.

In FIG. 25, the heat source 11e is sealed in the sealing material 4, without being joined to the semiconductor elements 2A, 2B. In this configuration, the heat source lie heats the semiconductor elements 2A, 2B via the sealing material 4.

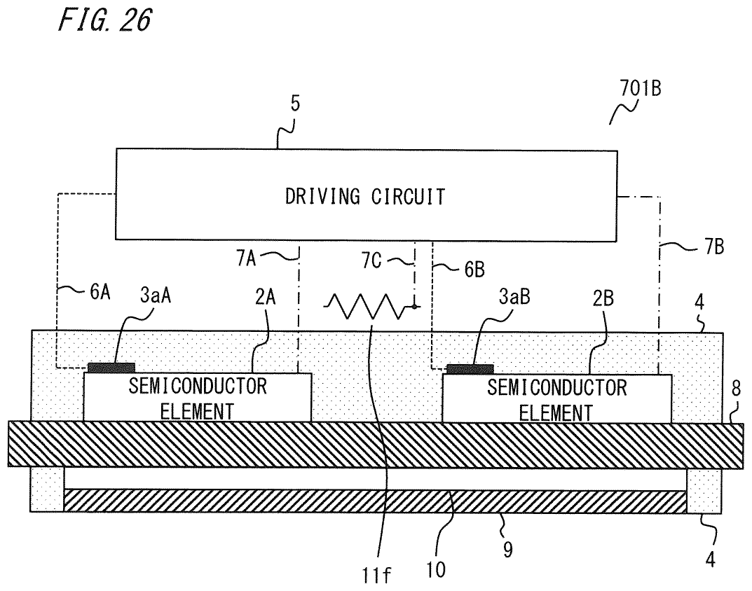

Next, a case where a heat source 11f is provided outside the sealing material 4, on the semiconductor element 2A, 2B side of the metal plate 8, will be described with reference to FIG. 26. In FIG. 26, the power conversion device and the heat source are respectively referred to as 701B and 11f, for discrimination from embodiments 5 and 12.

In FIG. 26, the heat source 11f is provided outside the sealing material 4, on a surface side of the metal plate 8 at which the semiconductor elements 2A, 2B are joined. In this configuration, the heat source 11f heats the semiconductor elements 2A, 2B via the sealing material 4.

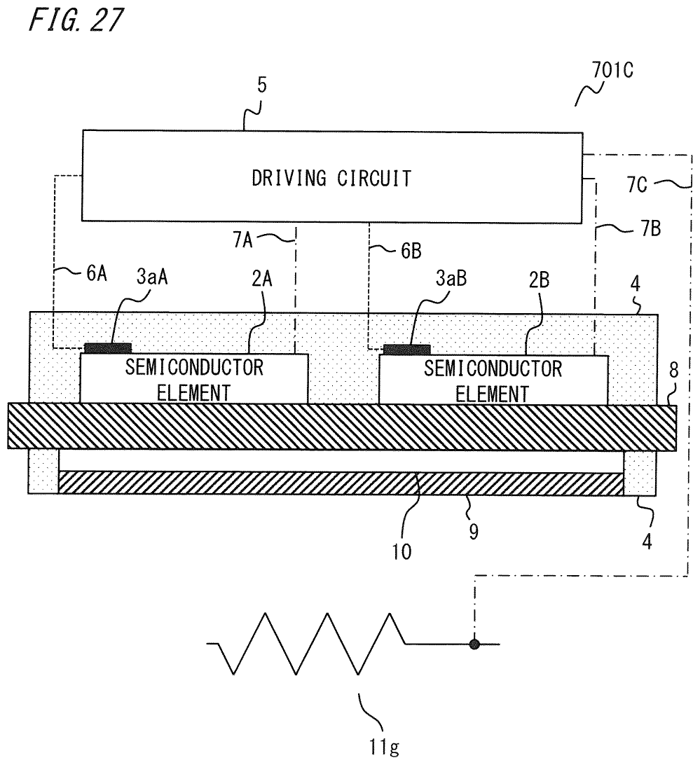

Next, a case where a heat source 11g is provided outside the heat dissipation material 9, on a side of the metal plate 8 opposite to the semiconductor elements 2A, 2B, will be described with reference to FIG. 27. In FIG. 27, the power conversion device and the heat source are respectively referred to as 701C and 11g, for discrimination from embodiments 5 and 12.

In FIG. 27, the heat source 11g is provided outside the heat dissipation material 9, on a side of the metal plate 8 opposite to the surface at which the semiconductor elements 2A, 2B are joined. In this configuration, the heat source 11g heats the semiconductor elements 2A, 2B and the sealing material 4 via the heat dissipation material 9, the joining material 10, and the metal plate 8.

When the modifications (FIG. 25 to FIG. 27) of the configuration of the power conversion device are collectively described, the configuration in FIG. 25 will be described as a representative.

As modifications of the placement position of the heat source 11a, the cases of FIG. 25 to FIG. 27 have been described. In any of these cases, the heat source 11e is sealed in the sealing material 4, provided outside the sealing material 4, or provided outside the heat dissipation material 9, instead of being provided in the semiconductor elements 2A, 2B or joined to the semiconductor elements 2A, 2B.

Using the configurations described in FIG. 25 to FIG. 27 increases processing steps for mounting to the power conversion device 701A. However, the process for mounting the semiconductor elements 2A, 2B and the heat source 11e to the power conversion device 701A can be performed by separate steps, whereby the mounting process can be improved advantageously.

As described above, in the power conversion device of embodiment 14, the placement position of the heat source is separated from the semiconductor elements 2A, 2B. Thus, the power conversion device of embodiment 14 can improve the withstand voltages at the interfaces between the semiconductor elements and the sealing material. In addition, the mounting process for the power conversion device can be improved.

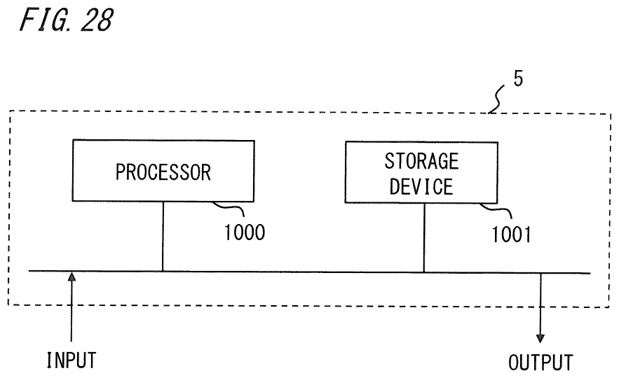

FIG. 28 shows a hardware example of the driving circuit 5 of the power conversion device. As shown in FIG. 28, the driving circuit 5 is composed of a processor 1000 and a storage device 1001. Although not shown, the storage device is provided with a volatile storage device such as a random access memory and a nonvolatile auxiliary storage device such as a flash memory.

Instead of the flash memory, an auxiliary storage device of a hard disk may be provided. The processor 1000 executes a program inputted from the storage device 1001. In this case, the program is inputted from the auxiliary storage device to the processor 1000 via the volatile storage device. The processor 1000 may output data such as a calculation result to the volatile storage device of the storage device 1001, or may store such data into the auxiliary storage device via the volatile storage device.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1, 101A, 101B, 101C, 201, 301A, 3018, 302C, 401, 501, 601A, 6018, 601C, 701A, 701B, 701C power conversion device
2, 2A, 2B semiconductor element
3, 3aA, 3aB, 3b, 3c, 3d, 3e, 3f, 3g temperature sensor
4, 4A, 4B sealing material
5 driving circuit
6, 6A, 6B temperature information transmission path
7, 7A, 7B, 7C control transmission path
8, 8A, 8B metal plate
9, 9A, 9B heat dissipation material
10, 10A, 10B joining material
11a, 11b, 11c, 11d, 11e, 11f, 11g heat source
1000 processor
1001 storage device

1. A power conversion device comprising:
a plurality of semiconductor element;
one or a plurality of temperature sensors;
a sealing material sealing the semiconductor elements; and
a driving circuit for the plurality of semiconductor elements, wherein
the one or plurality of temperature sensors measure a temperature of either or both of the plurality of semiconductor elements and the sealing material, and
on the basis of temperature information measured by the one or plurality of temperature sensors, the driving circuit
controls a voltage steepness or a voltage crest value to be applied to each of the plurality of semiconductor elements, individually, or
controls the voltage steepnesses or the voltage crest values to be applied to the plurality of semiconductor elements, using a common value.

2. The power conversion device according to claim 1, comprising a plurality of semiconductor modules each including the semiconductor element, the temperature sensor, and the sealing material.

3. The power conversion device according to claim 1, comprising a semiconductor module including the plurality of the semiconductor elements, the one or plurality of the temperature sensors, and the sealing material sealing the plurality of semiconductor elements.

4. The power conversion device according to claim 1, wherein
when the temperature measured by the temperature sensor has decreased, the driving circuit decreases the voltage steepness or the voltage crest value to be applied to the semiconductor element, and
when the temperature measured by the temperature sensor has increased, the driving circuit increases the voltage steepness or the voltage crest value to be applied to the semiconductor element.

5. The power conversion device according to claim 1, wherein
the driving circuit stores a control information map representing a relationship among withstand voltage at an interface between the semiconductor element and the sealing material, the voltage steepness, and the temperature of either or both of the semiconductor element and the sealing material, and
the driving circuit selects the voltage steepness or the voltage crest value to be applied to the semiconductor element, on the basis of the control information map.

6. The power conversion device according to claim 1, wherein
the temperature sensor is provided in the semiconductor element or sealed in the sealing material.

7. The power conversion device according to claim 1, further comprising a metal plate with the semiconductor element joined to one surface of the metal plate, wherein
the temperature sensor is sealed in the sealing material and is joined to the surface of the metal plate at which the semiconductor element is joined or a surface of the metal plate opposite to the surface at which the semiconductor element is joined.

8. The power conversion device according to claim 1, further comprising a heat source, wherein
when the temperature measured by the temperature sensor is lower than a steady temperature during driving of the semiconductor element, the driving circuit heats the semiconductor element and the sealing material, using the heat source.

9. The power conversion device according to claim 7, further comprising a heat source, wherein
when the temperature measured by the temperature sensor is lower than a steady temperature during driving of the semiconductor element, the driving circuit heats the semiconductor element and the sealing material, using the heat source.

10. The power conversion device according to claim 8, wherein
the heat source is provided in the semiconductor element, or sealed in the sealing material, or provided outside the semiconductor element and the sealing material.

11. The power conversion device according to claim 9, wherein
a heat dissipation material is joined to the metal plate via a joining material, and
the heat source is provided outside the heat dissipation material and the sealing material, and heats the semiconductor element and the sealing material via the metal plate, the heat dissipation material, and the joining material.

12. A power conversion device control method performed using a power conversion device including a plurality of semiconductor elements, one or a plurality of temperature sensors, a sealing material sealing the semiconductor elements, and a driving circuit for the plurality of semiconductor elements, the method comprising:
a temperature measurement step of measuring a temperature of either or both of the plurality of semiconductor elements and the sealing material by the one or plurality of temperature sensors;
a control value selection step of selecting a voltage steepness or a voltage crest value to be applied to the plurality of semiconductor elements on the basis of temperature information measured by the one or plurality of temperature sensors;
a control value adjustment step of adjusting the voltage steepness or the voltage crest value to be applied to the plurality of semiconductor elements, to the selected voltage steepness or voltage crest value; and
in the control value selection step, and the control value adjustment step,
the process is performed for the voltage steepness or the voltage crest value to be applied to each of the plurality of semiconductor elements, as an individual value, or
the process is performed for the voltage steepnesses or the voltage crest values to be applied to the plurality of semiconductor elements, as a common value.

13. The power conversion device control method according to claim 12, wherein
the driving circuit stores a control information map representing a relationship among withstand voltage at an interface between the semiconductor element and the sealing material, the voltage steepness, and the temperature of either or both of the semiconductor element and the sealing material,
the method further comprises
before the temperature measurement step, a required value setting step of setting a required value for the voltage steepness or the voltage crest value to be applied to the semiconductor element, and
after the control value adjustment step, an end determination step of comparing the required value for the voltage steepness or the voltage crest value set in the required value setting step, with the voltage steepness or the voltage crest value adjusted in the control value adjustment step, to determine whether or not to end a process,
in the control value selection step, the voltage steepness or the voltage crest value to be applied to the semiconductor element, at which the withstand voltage at the interface between the semiconductor element and the sealing material becomes a maximum value or a value allowable in designing, is selected on the basis of the temperature information measured by the temperature sensor and the control information map,
when the adjusted voltage steepness or voltage crest value is equal to or greater than the required value in the end determination step, the process is ended, and
when the adjusted voltage steepness or voltage crest value is smaller than the required value in the end determination step, the process returns to the temperature measurement step.

14. (canceled)

15. The power conversion device control method according to claim 12, wherein
the power conversion device includes a heat source,
the method further comprises a heating step after the control value adjustment step,
in the control value selection step,
when the temperature information has increased from a previous temperature, the voltage steepness or the voltage crest value is increased,
when the temperature information has decreased from a previous temperature, the voltage steepness or the voltage crest value is decreased, and
when the temperature information has not changed from a previous temperature, the voltage steepness or the voltage crest value is kept without being changed, and
in the heating step, on the basis of the temperature information measured by the temperature sensor, when the temperature measured by the temperature sensor is lower than a steady temperature during driving of the semiconductor element, the semiconductor element and the sealing material are heated.

16. The power conversion device control method according to claim 12, wherein
the power conversion device includes a heat source,
the driving circuit stores a control information map representing a relationship among withstand voltage at an interface between the semiconductor element and the sealing material, the voltage steepness, and the temperature of either or both of the semiconductor element and the sealing material,
the method further comprises
before the temperature measurement step, a required value setting step of setting a required value for the voltage steepness or the voltage crest value to be applied to the semiconductor element,
after the required value setting step, a heating temperature information acquisition step in which the driving circuit acquires the temperature information measured by the temperature sensor, a heating determination step in which the driving circuit performs comparison of a magnitude relationship between the temperature measured by the temperature sensor and a steady temperature during driving of the semiconductor element, and a heating step in which the driving circuit heats the semiconductor element and the sealing material when the temperature measured by the temperature sensor is lower than the steady temperature during driving of the semiconductor element, and
after the control value adjustment step, an end determination step of comparing the required value for the voltage steepness or the voltage crest value set in the required value setting step, with the voltage steepness or the voltage crest value adjusted in the control value adjustment step, to determine whether or not to end a process,
in the control value selection step, the voltage steepness or the voltage crest value to be applied to the semiconductor element, at which the withstand voltage at the interface between the semiconductor element and the sealing material becomes a maximum value or a value allowable in designing, is selected on the basis of the temperature information measured by the temperature sensor and the control information map,
when the adjusted voltage steepness or voltage crest value is equal to or greater than the required value in the end determination step, the process is ended, and
when the adjusted voltage steepness or voltage crest value is smaller than the required value in the end determination step, the process returns to the heating step.

17. The power conversion device control method according to claim 16, further comprising
after the required value setting step and before the heating temperature information acquisition step,
a provisional temperature information acquisition step in which the driving circuit acquires the temperature information measured by the temperature sensor,
a provisional control value selection step in which the driving circuit selects the voltage steepness or the voltage crest value that is a maximum value or a value allowable in terms of designing, for the voltage steepness or the voltage crest value to be applied to the semiconductor element, with reference to the required value for the voltage steepness or the voltage crest value set in the required value setting step, on the basis of the acquired temperature information and the stored control information map, and
a provisional control value adjustment step in which the driving circuit adjusts the voltage steepness or the voltage crest value to be applied to the semiconductor element, to the voltage steepness or the voltage crest value selected in the provisional control value selection step.

18. The power conversion device control method according to claim 13, wherein
in the required value setting step, and the end determination step,
the process is performed for the voltage steepness or the voltage crest value to be applied to each of the plurality of semiconductor elements, as an individual value, or
the process is performed for the voltage steepnesses or the voltage crest values to be applied to the plurality of semiconductor elements, as a common value.

19. The power conversion device according to claim 2, wherein
when the temperature measured by the temperature sensor has decreased, the driving circuit decreases the voltage steepness or the voltage crest value to be applied to the semiconductor element, and
when the temperature measured by the temperature sensor has increased, the driving circuit increases the voltage steepness or the voltage crest value to be applied to the semiconductor element.

20. The power conversion device according to claim 2, wherein
the driving circuit stores a control information map representing a relationship among withstand voltage at an interface between the semiconductor element and the sealing material, the voltage steepness, and the temperature of either or both of the semiconductor element and the sealing material, and
the driving circuit selects the voltage steepness or the voltage crest value to be applied to the semiconductor element, on the basis of the control information map.

21. The power conversion device according to claim 2, wherein
the temperature sensor is provided in the semiconductor element or sealed in the sealing material.
